(19) United States
(12) Patent Application Publication
(10) Pub. No.: US 2025/0373515 A1
(43) Pub. Date: Dec. 4, 2025

(54) MONITORING ENTITY AND METHOD FOR EVALUATING AN AI/ML MODEL IN A WIRELESS COMMUNICATION SYSTEM

(71) Applicant: FRAUNHOFER-GESELLSCHAFT ZUR FOERDERUNG DER ANGEWANDTEN FORSCHUNG E.V., Muenchen (DE)

(72) Inventors: Georgios KONTES, Erlangen (DE); Mohammad ALAWIEH, Erlangen (DE); Birendra GHIMIRE, Erlangen (DE); Alexander GOETZ, Erlangen (DE); Christopher MUTSCHLER, Erlangen (DE)

(21) Appl. No.: 19/301,616

(22) Filed: Aug. 15, 2025

Related U.S. Application Data
(63) Continuation of application No. PCT/EP2024/054054, filed on Feb. 16, 2024.

(30) Foreign Application Priority Data
Feb. 16, 2023 (EP) 23157093.8

(51) Int. Cl. H04L 41/16; H04W 24/08

(52) U.S. Cl. CPC H04L 41/16; H04W 24/08

(57) ABSTRACT

A monitoring entity for an AI/ML model used in a wireless communication system is configured to receive model data associated with the model and to execute an evaluation of the model data with respect to a reference model to obtain an evaluation result. The monitoring entity has a plurality of analyser modules, wherein each analyser module is configured for evaluating an associated set of parameters derived from the model data with respect to an evaluated property to determine an associated monitoring metric associated with the analyser module, the associated monitoring metric indicating a performance of the model with respect to the associated set of parameters. The monitoring entity is adapted to request, from a different network entity, additional information relating to the model and to use the additional information relating to the model for obtaining the plurality of associated monitoring metrics.

### CROSS-REFERENCE TO RELATED APPLICATIONS

This application is a continuation of copending International Application No. PCT/EP2024/054054, filed Feb. 16, 2024, which is incorporated herein by reference in its entirety, and additionally claims priority from European Application No. 23157093.8, filed Feb. 16, 2023, which is also incorporated herein by reference in its entirety.

### TECHNICAL FIELD

The present invention relates to a monitoring entity for an AI/ML model used in a wireless communication system, to devices or functions comprising such a monitoring entity, to a wireless communication system and to a method for evaluating an AI/ML model and a method to operate a device. The present invention in particular relates to AI/ML model monitoring an entity for mobile networks. Embodiments of the present invention relate to a monitoring and fault processing system for AI/ML model management in mobile networks.

### BACKGROUND OF THE INVENTION

In a wireless communication system there may be operated an AI/ML model to model a function, a behavior or a component of the system. However, such models may operate insufficiently. Examples of such AI/ML models relate to beam management, interference management, mobility management or resource allocation. For instance, non-AI/ML systems in 5G mobility management typically rely on reactive mechanisms, where handovers are triggered and executed based on historical measurements and events. While these non-AI/ML systems work well in certain scenarios, they can face challenges in high UE mobility or dense micro cell environments, resulting in issues like handover failures and throughput loss. For interference management and resource allocation, the use of AI/ML algorithms can utilize various factors such as network conditions, traffic patterns, and user demands to make intelligent decisions on how to allocate network resources effectively.

There is, thus, a need to enhance a use of AI/ML models in a wireless communication system. An object of the present invention is, thus, to provide for a solution to enhance the use of AI/ML models in wireless communication systems.

### SUMMARY

An embodiment may have a monitoring entity for an AI/ML model used in a wireless communication system, wherein the monitoring entity is configured to: receive model data associated with the model; execute an evaluation of the model data, using a plurality of analyser modules of the monitoring entity, wherein each analyser module is configured for evaluating an associated set of parameters derived from the model data with respect to an evaluated property to determine an associated monitoring metric associated with the analyser module, the associated monitoring metric indicating a performance of the model with respect to the evaluated property; and wherein the monitoring entity is adapted to request, from a different network entity, e.g., a UE or the network, additional information relating to the model; and to use the additional information relating to the model for obtaining the plurality of associated monitoring metrics.

Another embodiment may have a User Equipment, UE, adapted to operate in a wireless communication system, the UE having a monitoring entity according to the invention as mentioned above.

Another embodiment may have a base station, BS, adapted to operate in a wireless communication system, the BS having a monitoring entity according to the invention as mentioned above.

Another embodiment may have a core management function, adapted to operate in a wireless communication system, the core management function having a monitoring entity according to the invention as mentioned above.

According to another embodiment, a method for evaluating an AI/ML model used in a wireless communication system may have the steps of: receiving model data associated with the model; executing an evaluation of the model data, by evaluating a plurality of sets of parameters derived from the model data with respect to a plurality of evaluated properties, each evaluated property associated with a set of parameters, to determine an associated monitoring metric, the associated monitoring metric indicating a performance of the model with respect to the evaluated property; and requesting, from a different network entity, additional information relating to the model; and using the additional information relating to the model for obtaining the plurality of associated monitoring metrics;

A recognition of the present invention is that by monitoring the behavior of models, e.g., their effect or influence on the network, there may be provided a basis for determining the performance of the model in view of one or a plurality of sets of parameters to obtain respective monitoring metrics whilst by requesting from a different network entity additional information relating to the model, said information may be used for obtaining such associated monitoring metrics. The associated metric may indicate a performance of the model in view of the associated set of parameters which may be taken, alone or in combination with other monitoring metrics as an evaluation result. Such a performance or evaluation result may sometimes indicate a fault, e.g., comprise a fault indicator but may also comprise other categories of evaluation.

According to an embodiment, a monitoring entity for an AI/ML model used in a wireless communication network is adapted to receive model data associated with the model. The monitoring entity is adapted to execute an evaluation of the model data by use of a plurality of analyser modules., e.g., to obtain an evaluation result. The evaluation entity comprises a plurality of analyser modules, wherein each analyser module is configured for evaluating an associated set of parameters derived from the model data with respect to an evaluated property to determine an associated monitoring metric associated with the analyser module, the associate monitoring metric indicating a performance of the model with respect to the associated set of parameters. The monitoring entity is adapted to request, from a different network entity, additional information relating to the model and to use the additional information relating to the model for obtaining the plurality of associated monitoring metrics.

Further embodiments relate to a user equipment, UE, to a base station and to a core management function comprising such a monitoring entity.

According to an embodiment, a method for evaluating an AI/ML model used in a wireless communication system, comprises receiving model data associated with the model; executing an evaluation of the model data, by evaluating a plurality of sets of parameters derived from the model data with respect to a plurality of evaluated properties, each evaluated property associated with a set of parameters, to determine an associated monitoring metric, the associated monitoring metric indicating a performance of the model with respect to the evaluated property; and requesting, from a different network entity, additional information relating to the model; and using the additional information relating to the model for obtaining the plurality of associated monitoring metrics.

According to an embodiment a method to operate a device in a wireless communication system comprises configuring a different device to operate as a monitoring entity as described herein. Such a method allows to obtain an evaluation results, e.g., when determining a demand for update and/or when determining a misalignment in the behavior of a wireless communication network. Further advantageous embodiments are defined in the dependent claims.

### BRIEF DESCRIPTION OF THE DRAWINGS

Embodiments of the present application are described hereinafter whilst making reference to the accompanying drawings in which:

FIG. 1 is a schematic representation of an example of a network infrastructure operated in accordance with embodiments;

FIG. 2 shows a schematic illustration of a relationship between a logical and a physical model according to an embodiment;

FIG. 3 shows a schematic block diagram of a monitoring entity according to an embodiment;

FIG. 4A shows a schematic block diagram of a monitoring entity according to an embodiment that is adapted to receive model input;

FIG. 4B shows a schematic diagram illustrating information transmitted between entities of FIG. 4A;

FIG. 5A shows a schematic block diagram of a monitoring entity according to an embodiment that is adapted to evaluate a model that is operated at the network;

FIG. 5B shows a schematic flow chart of signals and/or actions similar to the illustration presented in FIG. 4B relating to the configuration of FIG. 5A;

FIG. 6 shows a schematic block diagram indicating sources of information of a monitoring entity according to an embodiment;

FIG. 7 shows a schematic block diagram of a possible implementation of a fault detection module according to an embodiment;

FIG. 8 shows a schematic block diagram of the fault diagnosis module according to an embodiment;

FIG. 9 shows a schematic flow chart of a method according to an embodiment; and

FIG. 10 shows a schematic flow chart of a method for configuring a device.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present invention. However, it will be apparent to those skilled in the art that embodiments of the present invention may be practiced without these specific details. In other instances, well known structures and devices are shown in block diagram form rather than in detail in order to avoid obscuring embodiments of the present invention. In addition, features of the different embodiments described hereinafter may be combined with each other, unless specifically noted otherwise.

Embodiments described herein relate to use and/or evaluate a use of a model in a wireless communication system or network. A model described herein may model a specific component of the wireless communication network but is not limited to a modeling of a component. For example, an AI/ML model may, in general case, be used to support an application, for example, to predict the UE position in a positioning process/function, to select a specific beam for a beam management function or the like. Further, a model is not limited to a single component or a single function that may also relate to a set of components, functions respectively.

A model described herein may relate, in general, to an AI/ML model. That is, the model may comprise a machine learning functionality and/or artificial intelligence, e.g., by incorporating, learning and/or using neural networks that allow to emulate or reproduce a model status of the network at least in parts with regard to a past, present or future state or condition.

According to an embodiment, a device may be adapted for functionality identification: This may include execution of a process/method of identifying an AI/ML functionality for the common understanding between the NW and another device such as a UE. Information regarding the AI/ML functionality may be shared during functionality identification. Where AI/ML functionality resides depends on the specific use cases and sub-use cases. That is, the functionality may be located at different devices.

Some embodiments described herein relate to functionality provided by, e.g., a device or method. A functionality may refers to an AI/ML-enabled Feature/FG enabled by at least one configuration, where the configuration(s) is (are) supported based on conditions, e.g., indicated by UE capability. Correspondingly, a functionality-based life cycle management, LCM, may operate based on, at least, one configuration of AI/ML-enabled Feature/FG or specific configurations of an AI/ML-enabled Feature/FG.

According to embodiments, for using an AI/ML model, an entity or device may model a single component or functionality by use of different instances of models.

In general, an AI/ML model may be identified by a model ID that may be referred to as logical, e.g., identifying the components or functions to be modelled. Such a logical model may be realized by different physical AI/ML models such that the term logical AI/ML model may be understood as referring to a model that is identified and, e.g., assigned a model ID whilst a physical AI/ML model may refer to an actual implementation of such a model. In connection with embodiments described herein, when referring to an activation/deactivation, to a switch of a functionality, to a fallback solution provided in response to the performance evaluated according to the invention, such a change, e.g., in a logical model may imply an activation, deactivation, switch, fallback respectively in a functionality level and, thus, in a physical AI/ML model.

Further, according to embodiments, there may be identified a need to change or modify a model to be used. Such a change may refer to both, the level of logical models and the level of physical models. For instance, the logical model may relate to a load scenario of at least a part of a network where different models may be used when having a low number of users when compared to having a high number of users. In addition or as an alternative to load scenarios and user numbers, environmental conditions and channel measurements can be considered when adapting or changing the logical model. For example, the logical model used in the network can be adjusted based on factors such as SINR, geographical location, environment dynamics, speed, environment changes or even weather conditions. Adapting or changing the model may, thus, relate to changing the logical model. However, one or more logical models may be implemented in a device in different ways thereby resulting in at least two physical models relating to the same logical model. An adaptation or a change may, thus, as an alternative or in addition, relate to a corresponding action between physical model, e.g., changing the implementation of the model as one being able to be adapted in shorter time or being operated more precise or accurate whilst consuming additional power or the like.

Embodiments described herein relate to determining a fault in a model or a use thereof. Determining such a fault may cause one or more actions that are described hereinafter. However, embodiments of the present invention are not limited to detecting faults of a model to be addressed. A fault may indicate a lack of performance of a model and embodiments of the present invention in general relate to a monitoring metric that is to be determined and that indicates a performance of the model. Such a monitoring metric or a performance of a model may not only relate to faults of the model and the operation but also to an accuracy, distribution/statistics of the input/output data or other properties related to the model.

According to an embodiment not limiting the present invention, the functionality of a model may relate to beam management.

A device implementing an algorithm or performing a method to provide or at least participate in beam management may, for example
have access to a codebook having M beams
measure beams of set B, e.g., sporadically, upon request or periodically, e.g., with a periodicity of measurements, such as several ms.
after this happens for a predefined times related to a number of measurements before prediction times, the device may provide, indicate or transmit a signal indicating a beam ID measured, an RSRP level of measurement as an input to the AI/ML model, to predict the best beam(s) from Set A as output.

With regard to set A forming a subset of M and set B may comprise same or different beam patterns, the following may apply: set B may indicate a set of beams that is measured, set A may indicate a set of possible best beams to be predicted by AI/ML model.

Functionalities of the device or model may be summarized according to the example in the following table, e.g., related to different use cases or measurement intervals:

| | | | | Periodicity of |
|---|---|---|---|---|
| | | | | measurement / |
| | | Beam | Pattern of | number of |
| | | codebook | Set B | measurements |
| Functionality | | size / Set | measured | before |
| ID | Use Case | B / Set A | beams | prediction |
| Functionality | Beam | 64 / 8 / 56 | Same as Set | 80 ms / 4 |
| #1 | management / | | A | |
| | moving UE | | | |
| Functionality | Beam | 64 / 8 / 56 | Same as Set | 160 ms / 2 |
| #2 | management / | | A | |
| | moving UE | | | |
| Functionality | Beam | 64 / 8 / 56 | Same as Set | 320 ms / 1 |
| #3 | management / | | A | |
| | static UE | | | |
| Functionality | Beam | 64 / 6 / 64 | Beams in Set | 80 ms / 4 |
| #4 | management / | | B are wider | |
| | moving UE | | than beams | |
| | | | in Set A. In | |
| | | | this case, set | |
| | | | A contains all | |
| | | | (narrow) | |
| | | | beams of the | |
| | | | codebook. | |
| Functionality | Beam | 256 / 56 / 200 | Same as Set | 80 ms / 4 |
| #5 | management / | | A | |
| | moving UE | | | |
| . . . | | | | |

Another functionality may relate to positioning. Different functionalities of the same or a different model may relate to:

| Functionality | | | | Periodicity of |
|---|---|---|---|---|
| ID | Use Case | Input | Output | prediction |
| Functionality | Direct | Full CIR | 3d position | 320 ms |
| #11 | Positioning | | | |
| Functionality | Direct | Power Delay | 3d position | 160 ms |
| #12 | Positioning | Profile | | |
| Functionality | Direct | Delay Profile | 3d position | 160 ms |
| #13 | Positioning | | | |
| Functionality | Assisted | Full CIR | ToA | 320 ms |
| #14 | Positioning | | | |
| Functionality | Assisted | Full CIR | LOS/NLOS | 320 ms |
| #15 | Positioning | | | |
| . . . | | | | |

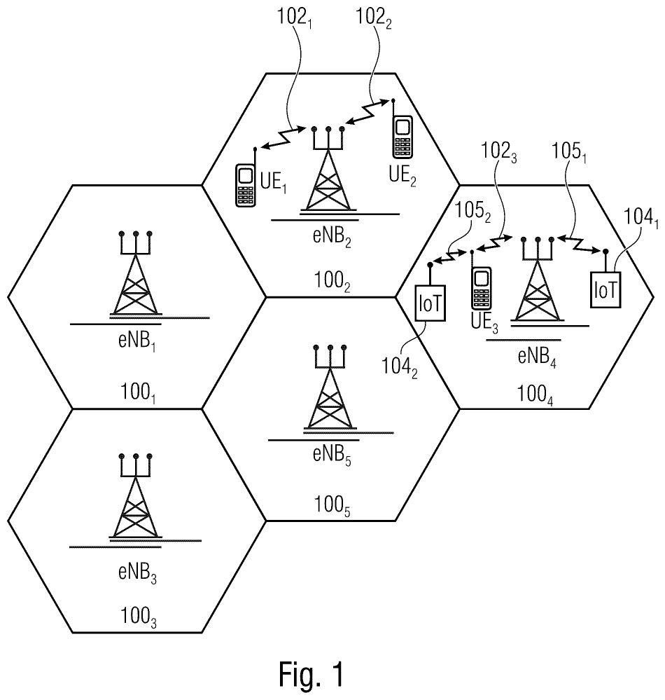

FIG. 1 is a schematic representation of an example of a network infrastructure, like a wireless communication system including a plurality of base stations eNB₁ to eNB₅, each serving a specific area surrounding the base station schematically represented by the respective cells 100₁ to 100₅. The base stations are provided to serve users within a cell. A user may be a stationary device or a mobile device. Further, the wireless communication system may be accessed by IoT, (internet of things) devices which connect to a base station or to a user. FIG. 1 shows an exemplary view of only five cells, however, the wireless communication system may include more of such cells. FIG. 1 shows two users UE₁ and UE₂ also referred to as user equipment, UE, that are in cell 100₂ and that are served by base station eNB₂. Another user UE₃ is shown in cell 100₄ which is serve by based station eNB₄. The arrows 100₁ 100₂ and 100₃ schematically represent uplink/downlink connections for transmitting data from a user UE₁, UE₂ and UE₃ to the base stations eNB₂, eNB₄ or for transmitting or for transmitting data from the base stations eNB₂, eNB₄ to the users UE₁, UE₂, UE₃.

Further, FIG. 1 shows two IoT devices 104₁ and 104₂ in cell 100₄, which may be stationary or mobile devices. The IoT device 104₁ accesses the wireless communication system via the base station eNB₄ to receive and transmit data as schematically represented by arrow 105₁. The IoT device 104₂ accesses the wireless communication system via the user UE₃ as is schematically represented by arrow 105₂. UE₁, UE₂ and UE₃ may access the wireless communication system or network by communicating with the base station. However, embodiments are not limited hereto as an alternative or in addition, users UE₁, UE₂ and UE₃ may perform sidelink communication or peer-to-peer communication.

The wireless communications network or its system may be any single-tone or multi carrier system based on frequency-division multiplexing, like the orthogonal frequency-division multiplexing (or FDM) system, the orthogonal frequency-division multiple access (OFDMA) system defined by the LTE standard, or any other IFFT-based signal with or without CP, e.g., DFT-SOFDM. Other wave forms, like non-orthogonal wave forms for multiple access, e.g., filter bank multi carrier (FBMC), may be used. Other multiplexing schemes like time-division multiplexing (time-division duplex/TDD) may be used.

One or more devices operated in the wireless communication system presented in FIG. 1 may use or operate a model for modelling the behavior of itself and/or of a different device. As an alternative or in addition, a model may be used to model one or more parameters forming at least a part of a scenario that is faced by a different entity or the device that operates the model.

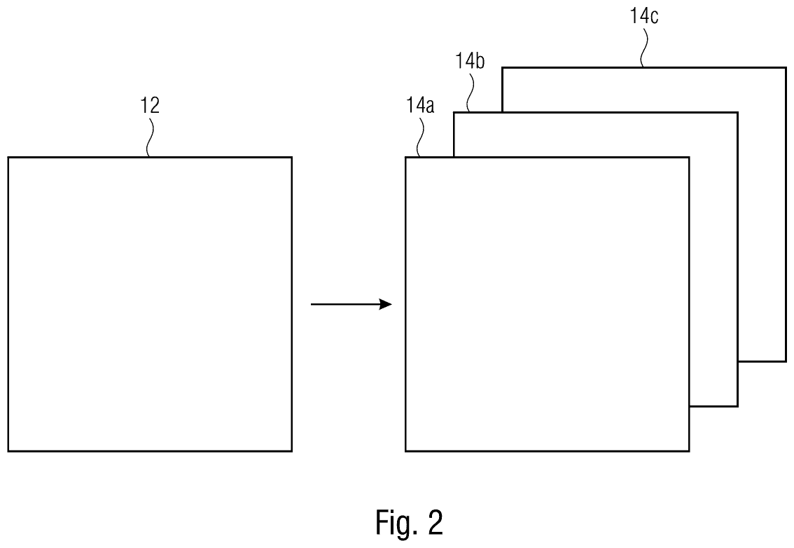

FIG. 2 shows a schematic illustration of a model 12 that may be referred to as a logical model. FIG. 2 further shows an example number of three physical models 14a, 14b and 14c that are implementations of the logical model 12. For example, logical model 12 may be defined or formulated within some boundaries with regard to an accuracy, a scenario within a wireless communication network such as the one illustrated in FIG. 1, an entity implementing the model or the like. For example, within the operation of a wireless communication network, the logical model 12 may be instructed by a base station or another controlling or supervising entity to be used, e.g., during a specific period of time, based on an event that has happened, is happening or is expected to happen, whilst different physical model 14a-c may be implementation, e.g., provided by different manufacturers, model providers or mobile network operators that implement model 12 within the specified boundaries.

For example, different manufacturers of a UE may implement different physical models 14, each in accordance with the logical model 12. However, this is only one example and does not exclude devices that operate different physical models 14a-c between which there may be selected one or a subset based on one or more constraints such as computational power used, accuracy, allowed impreciseness or the like. In other words, the logical model 12 may be defined, e.g., by the base station, a mobile network operator or a mobile communication standard to be followed, e.g., using a model ID or the like. The physical models 14a-c may be an implementation thereof, at least some aspects of the implementation remaining unspecified by the supervising entity. It is to be noted that the number of physical models may be one or more than one, e.g., more than two, more than three or even larger.

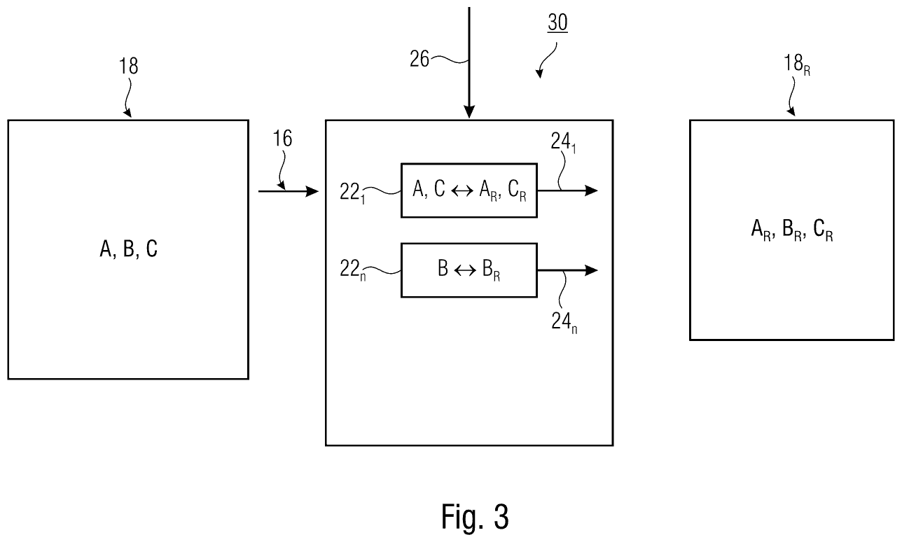

FIG. 3 shows a schematic block diagram of a monitoring entity 30 according to an embodiment. Monitoring entity 30 may be a dedicated or distributed entity i.e., may comprise one more several devices. In an embodiment, the monitoring device 30 is implemented or forms a part of a user equipment or a base station or a core management function that may comprise a location management function, LMF, a communication management function, CMF and/or a network data analytics function, NWDAF. For example, the monitoring entity 30 may operate as the monitoring entity in the wireless communication network based on receiving a request to provide evaluation results. For achieving this, a method according to an embodiment comprises configuring a different device, e.g., using a wirelessly transmitted signal, to operate as a monitoring entity described herein. For example, the base station may request one or more other devices such as IoT devices, UEs and/or other base stations to operate as monitoring entities or a part thereof. Alternatively or in addition, a user equipment may transmit a signal to other user equipment or a base station requesting an evaluation of a model that is implemented by the user equipment itself or by a different device.

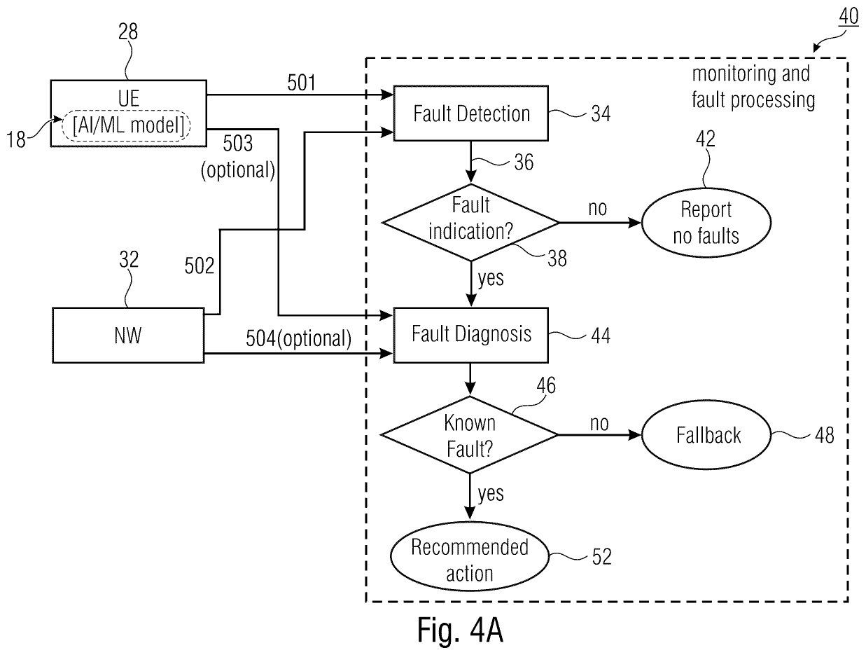

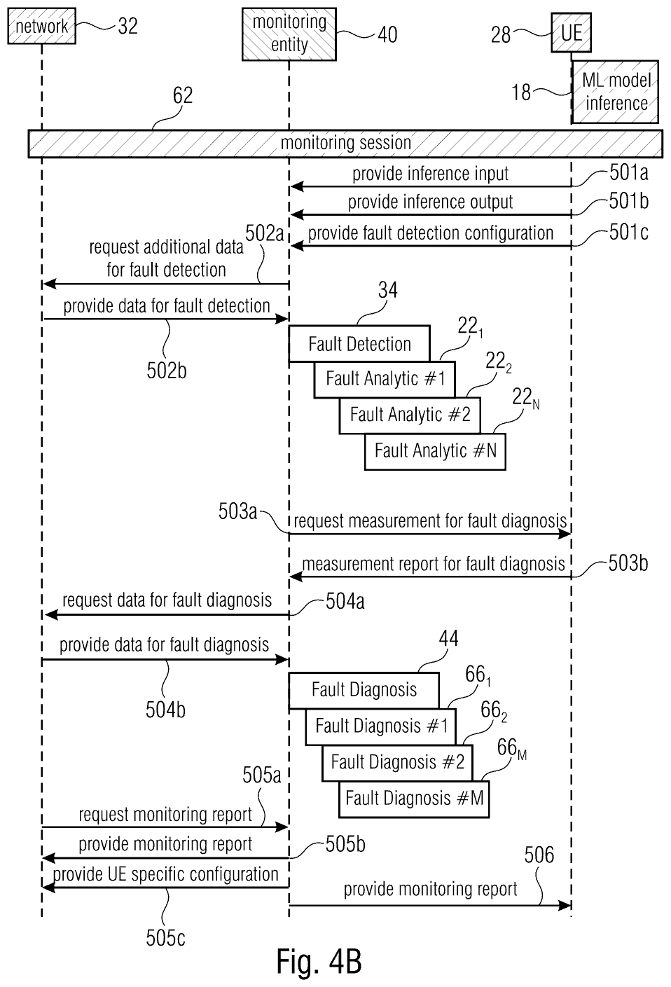

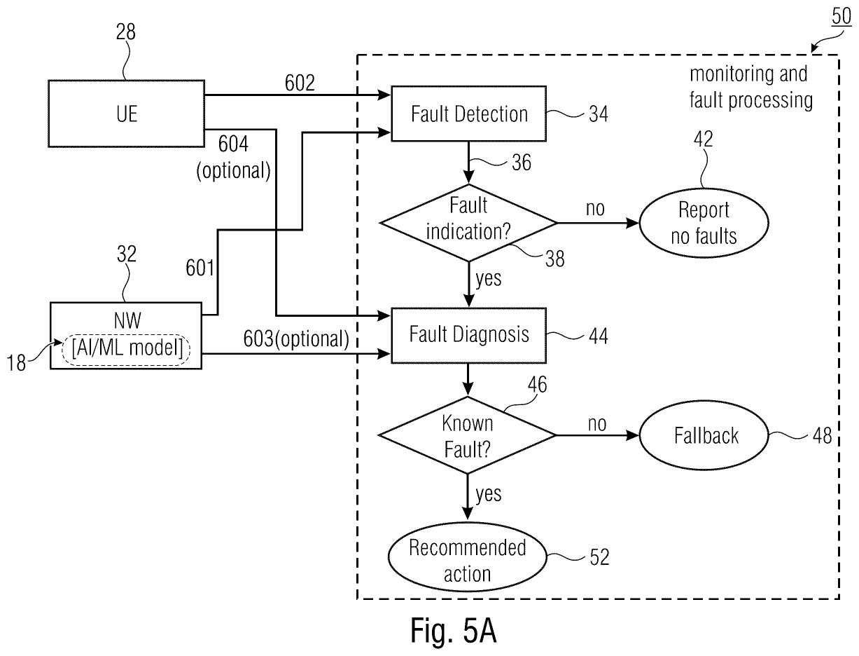

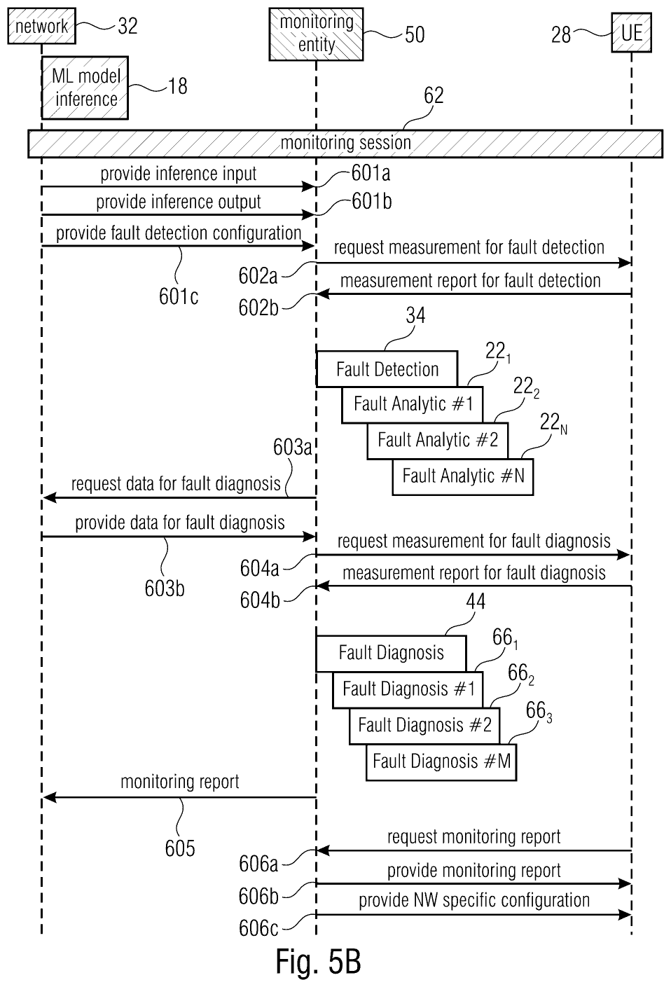

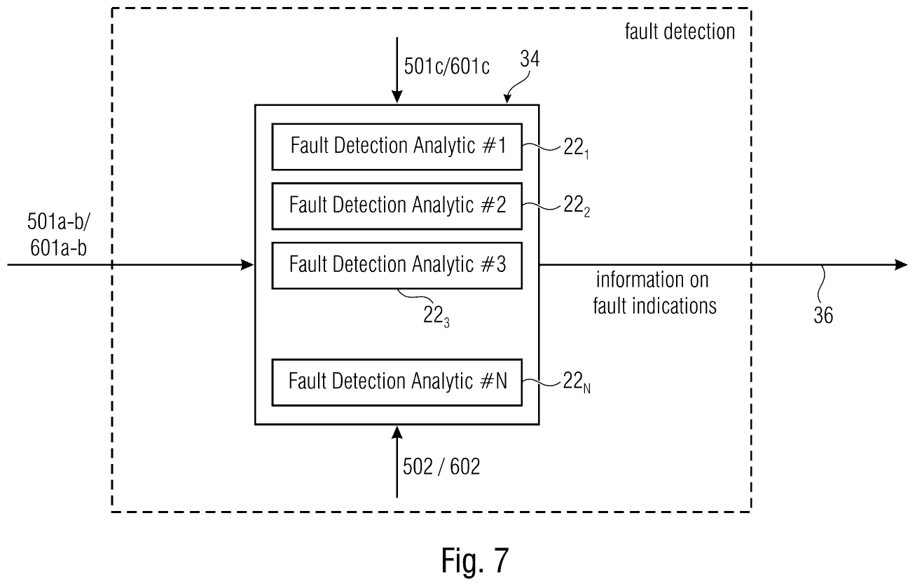

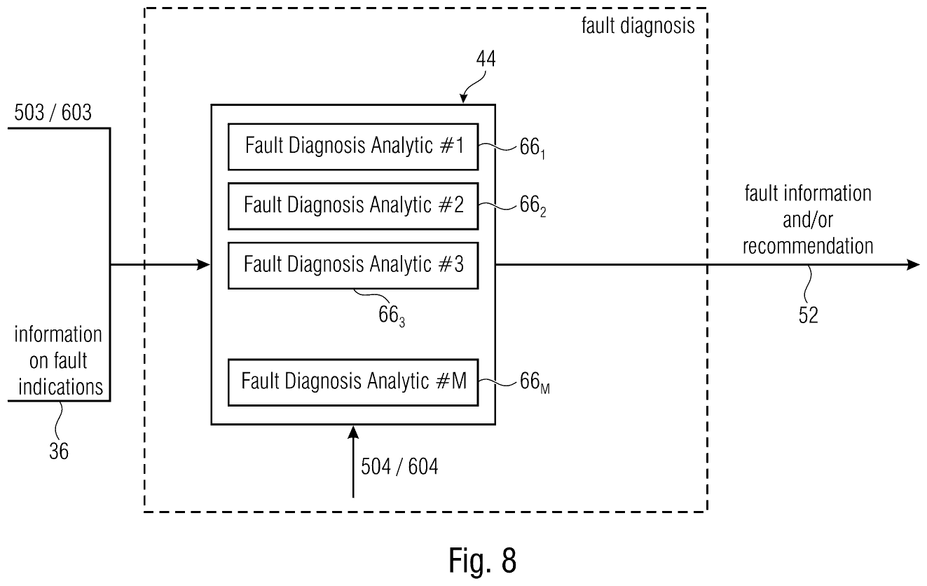

The monitoring entity 30 may be configured to receive model data 16, the model data 16 associated with a model 18 to be evaluated, e.g., a logical model 12 or a physical model 14 described in connection with FIG. 2. the model data 16 may be received during calibration, configuration, reconfiguration, manufacturing or during operation, e.g., using a wireless signal and/or may be stored in a memory or a plurality of memories of monitoring entity 30. Monitoring entity 30 may be implemented to execute an evaluation of the model data 16. The evaluation may be executed, by way of example, with respect or compared to reference model or reference model data 18_{R} to obtain an evaluation result. As will be described in connection with FIG. 4B, FIG. 5B, FIG. 7 and FIG. 8 evaluation of the model data may be based on a plurality of analyser modules, each evaluating the model data, a specific set of parameters thereof respectively with regard to an associated or specific property to obtain an monitoring metric that indicates a performance of the model in view of the evaluated property.

For example, each of the analyser module may indicate with a respective result or output an indication, value or other type of metric indicating the performance such as within a tolerance, as desired, out of tolerance, a value within a scale having a first value related to a minimum performance and second value indicating a maximum performance or the like. In one example, each of the analysers may indicate whether the model data is above a performance threshold, e.g., “ok”, or below a performance threshold, .e.g., “not ok”. Each of the monitoring metric may form at least a part of the overall evaluation result or may, e.g., when considering a hierarchical order of the parameters, form the evaluation result. Alternatively, a collection or even a combination to a combined metric may form at least a part of the evaluation result. For example, for a combination of the plurality of associated monitoring metrics, the device may implement a weighting for at least one, some or all monitoring metrics to adjust an amount of contribution to an overall evaluation result. Alternatively or in addition, an averaging procedure may be applied over weighted and/or unweighted monitoring metrics.

For example, model data 18 may comprise, indicate or relate to one or several sets of parameters A, B and C or which the reference model 18_{R} comprises reference AR B_{R} C_{R}.

The monitoring entity 30 comprises a plurality of two or more analyser modules 22₁, . . . 22ₙ with n>1, e.g., at least 2, at least 3, at least 4, at least 5, at least 10 or even larger. An analyser module may be configured for evaluating an associated set of parameters derived from the model data 18 with respect to an evaluated property to determine an associated monitoring metric 24₁, . . . , 24ₙ, the associated monitoring metric 24 associated with the analyser module 22. Each of the analyser modules 22₁, . . . , 22ₙ may be adapted for evaluating the associated set of parameters so as to comprise one or more parameters. As described by way of an example for analyser module 22₁, two parameters A and C may be evaluated with regard to the reference model 18_{R}. Analyser module 22ₙ may be adapted to compare only a single parameter as the associated set of parameters, e.g., parameter B.

A monitoring metric 24₁, . . . , 24ₙ may indicate, at least in connection with the associated set of parameter, a performance of the model 18 with respect the set of parameters. For example, each of the analyser modules 22₁ to 22ₙ may be adapted to evaluate or examine an associated part of the model 18 identified by the set of parameters.

The evaluation result provided by the monitoring entity 30 may be based on the plurality of associated monitoring metrics 24₁ to 24ₙ. The evaluation result and/or the at least one associated monitoring metric 24 may comprise a performance characteristic of the AI/ML model 18. For example, the performance characteristic may indicate a fault of the AI/ML model, e.g., a situation where the deviation between the reference 18_{R} and the model 18 exceeds a predetermined threshold. Other types of performance characteristics such as a accuracy, a speed, computational efforts entailed, used communication resources or the like may form at least a part of the evaluation performed by monitoring entity 30.

Further, the monitoring entity 30 is adapted to request from a further network entity additional information 26 relating to the model 18 which incorporates additional information being requested with regard to the model 18R. the monitoring entity uses the additional information 26 relating to the model for obtaining the plurality of associated monitoring metrics 24₁ to 24ₙ. For example, the additional information may relate to at least one of:
information obtained from beam codebook configuration;
transmit beam and/or receive beam spatial information;
information related with one or more resources or resource sets, e.g., for transmitting signals;
information related with the differential information between one or more resources and/or resource sets and/or frequency layers and/or TRPs used for communication;
a relative device rotation for a device forming a beam; and
a Quality of Service, QoS, parameter monitored at a network side.

Such additional information 26 may be received from the device that is requested or from another device. For example, the monitoring entity 30 may request the additional information 26 from a UE that forwards the request, e.g., to a base station or to a network function capable of responding to the request. Alternatively, the UE may provide the information in a case where the information is available at the UE. Alternatively or in addition, the monitoring entity 30 may direct its request to the network, e.g., a base station or a network function.

The request and/or the response may be transmitted, for example, by a wired or wireless signal using respective interfaces.

A performance to be evaluated or determined with regard to the set of parameters may thus allow to determine at least a part of a model performance. This may be related to one or more aspects. Example aspects may comprise:

### 1) AI/ML Model Prediction Accuracy (Requires Reference/True Data With the “Correct Answer”)

Examples for beam management:
Top-1 prediction accuracy
   There are 64 possible beams
   The model predicts one beam (out of 64) that could be the best one
   Top-1 prediction accuracy is calculated as the average of successful predictions (predicted beam==best beam) for N number of predictions (time-steps). Knowledge of the best beam is required here.
Top-K prediction accuracy
   There are 64 possible beams
   The model predicts K beams (e.g., 5 out of 64) that could be the best ones
   Top-K prediction accuracy is calculated as the average of successful predictions (one of K predicted beams==best beam) for N number of predictions (time-steps). Knowledge of the best beam is required here.

Examples for positioning:
Assisted positioning:
   F1-score of LOS/NLOS classification
      There is an AI/ML model that classifies between LOS/NLOS
      F1-score is a mathematical formula that takes into account false positive, false negative, true positive and true negative predictions into account, for N number of predictions (time-steps). Knowledge of the true LOS/NLOS class is required here.
   Mean squared error of ToA estimation
      There is an AI/ML model that estimates ToA for a single TRP
      Mean squared error is calculated as the average of the squared error between the predicted and true ToA, for N number of predictions (time-steps). Knowledge of the true ToA is required here.
Direct positioning
   Root squared error between predicted and “true” 3d position
      There is an AI/ML model that predicts 3d position directly
      The “true” position (or a good estimate of it) is available.
      The Euclidean distance between the predicted and the “true” 3d position is provided. Knowledge of the true 3d position is required here.

### 2) System Performance as a Result of AI/ML Model Performance (if System Performance KPIs are “High,” we can Assume That AI/ML Model Operates/Performs as Expected)

Examples from beam management:
Link quality related KPIs, e.g., throughput, L1-RSRP, L1-SINR, hypothetical BLER

### 3) Input Data Distribution as an Indicator of AI/ML Model Performance

Reasoning: if the input data distribution to the AI/ML model has similar statistics to the input data distribution used for AI/ML model training, the model is expected to perform well (it has “seen” similar data during training). If the statistics are not “similar,” then the model might not perform as expected.

Examples for both positioning and beam management
norm of model input, mean, min/max of some statistics related to measurement and/or model input, median or data temporal/spatial distribution.
identify and extract important parameters or properties that contribute to the model's performance or behavior. For example, this module extracts features related to channel characteristics, such as fading statistics, channel impulse response, or channel coherence time.

### 4) Output Data Distribution as an Indicator of AI/ML Model Performance

Reasoning:
if the output data distribution to the AI/ML model has similar statistics to the output data distribution used for AI/ML model training, the model is expected to perform well (it has “seen” similar data during training). If the statistics are not “similar,” then the model might not perform as expected, e.g., a possible fault, or low performance might be determined.
If the output does not make physical sense (e.g., the predicted 3d positions of a UE in the last N time-steps indicate that it is “teleporting” between positions or rooms), then this is an indicator of poor AI/ML model performance.

Examples from beam management:
The AI/ML model predicts spatially uncorrelated beams between time-steps (beam hoping).
The AI/ML model switches between predicted beams too fast (beams are spatially correlated, but this could imply that UE speed has significantly changed and maybe current model is no longer the most suitable one)

Examples from positioning:
Statistics of model output compared to the statistics associated with the training data. Examples include norm of model input, mean, min/max of some statistics related to measurement and/or model input, median or data temporal/spatial distribution.
Based on the last N 3d positions predicted by the AI/ML model, the UE appears to follow non-physical trajectory (e.g., “teleporting,” no-smooth track, etc.).

The performance of a model may be determined, for example, in view of an accuracy, e.g., of a beam prediction and/or positioning. Alternatively or in addition a link quality or interference related performance may be evaluated.

With regard to the different performance criteria, different analyser modules of a device may be adapted to evaluate different performances, e.g., at least one for the beam management and at least one for positioning, at least one for link quality and so on. Those analyser modules may be used in parallel or at least one of them may be selected to be used, possibly leaving others unused to evaluate one or more specific performances.

There are also additional monitoring metrics, that look at different dimensions of model performance and that may be evaluated in addition or as an alternative. For example, a latency or inference latency of the AI/ML model may be evaluated, which can be critical depending on the application.

Alternatively or in addition, a complexity and/or overhead related to the AI/ML model may be evaluated. This may includes factors like (inference) power consumption, memory/storage and hardware requirements. This monitoring metric provides a relative output value (relative improvement), compared to a baseline model/algorithm.

FIG. 4A shows a schematic block diagram of a monitoring entity 40 according to an embodiment. The monitoring entity 40 may be adapted to receive model input 501 that may be the model data 16 of FIG. 3. Further, the monitoring entity 40 may receive additional information 502 that may be, for example, the additional information 16 described in connection with FIG. 2.

A UE 28 may operate the AI/ML model 18. Additional information 503 may be received from the UE 28 and/or additional information 504 may be received from the network 32, e.g., at least one other device such as a UE, a base station or a network function. Additional information 503 and/or 504 may comprise, for example, measurement data or other useful information.

The monitoring entity 40 may be adapted for a two-step analysis where a fault detection module or function 34 may be configured to determine a performance indicator or performance characteristic 36 is determined, to indicate whether a fault or a degraded performance is happening. If a decision thereof relating to whether a degraded performance or a fault is indicated leads to the result “no”, then a report 42 that may optionally be generated may indicate that no fault or no performance degradation is present. If, however, the answer of step 38 is “yes”, then a fault diagnoses module 44 may examine whether the reason of effect or situation that is determined, e.g., causing step 38 to answer yes, is known in a step 46. If the result is no, i.e., that an unknown reason leads to the situation leading to fault detection to identify the presence of a fault or a degraded performance, then, optionally, a recommended action or fallback option 48 may be executed, reported and/or recommended to another entity. If the answer of step 46 is, however, yes, i.e., that the reason for the underlying situation may be determined or is known, then the monitoring entity 40 may cause, report or recommend a recommended action 52 that may cause one or more entities including but not necessarily requiring the monitoring entity 40 to adapt an operation and/or to perform certain actions.

For example, with regard to fall back option 48, it may be determined that a fault or degraded performance of model 18 is present but that the reason for such degradation or fault is unknown, the fall back option 48 may indicate to deactivate model 18 or to switch to another model. If the reason is known and it is possible to recommend a specific action in connection with model 18, for example, a model update, a change of the model or the like may be recommended.

The monitoring entity 40 may at least in parts be operated at the UE 28, the network 32 or a different device.

FIG. 4B shows a schematic diagram illustrating information transmitted between network 32, UE 28 and the monitoring entity 40. As described in connection with FIG. 4A, UE 28 may operate or use model 18 which may be referred to as model inference for the AI/ML model.

A monitoring session 62 may be used for obtaining measurement data, measurement values and/or measurement reports at the network 32, the monitoring device 40 and/or the UE 28. As part of information 501, the UE may report inference input 501a, i.e., input information of model 18. Alternatively or in addition, UE 28 may report inference output 501b to monitoring entity 40. Alternatively or in addition, fault detection configuration 501c may be reported to monitoring entity 40.

Monitoring entity 40 requests additional data for fault detection, e.g., transmitting a signal 502a to receive data for fault detection with a signal 502b shown as signal 502 in FIG. 4A, e.g., to receive additional information 26 of FIG. 3.

A fault detection module 34 of monitoring entity may comprise the analyser modules 22₁ to 22_{N} that may examine the information received with signal 501a, 501b, 501c and 502b with regard to a presence of a fault. Optionally, a signal 503a may be transmitted to UE 28 to request measurements to support the fault diagnosis which may be received in a signal 503b from UE 28.

Optionally, a signal 504a may be transmitted from monitoring entity 40 to the network 32 to request additional data for fault diagnosis that may be received with a signal 504b. Fault diagnosis module 44 may comprise one or more fault diagnosis modules 64₁ to 64_{M} to examine one or more possible faults responsive to fault detection 34 indicating a presence of a fault. Each of the fault diagnosis modules or performance diagnosis modules 66₁ to 66_{M} may provide a yes/no indication with regard to a fault that is possibly associated with the respective performance diagnosis modules 66 or may provide further information such as a level of performance, e.g., a level of the fault, a measure for a deviation with regard to a reference value, e.g., a measure of a misalignment or mismatch or other sorts of information.

The network may transmit an optional signal 505a to monitoring entity 40 directly or indirectly to request a monitoring report. Such a report may be provided with a signal 505b from the monitoring entity 40 to network 32. The monitoring entity 40 may provide for a UE specific configuration or other types of a recommended action 52 by use of a signal 505c and/or may provide the same or a different monitoring report when compared to signal 505b to UE 28 by use of a signal 506.

FIG. 5A shows a schematic block diagram of a monitoring entity 50 according to an embodiment that is adapted to evaluate model 18 that is operated at the network 32.

Similarly to the monitoring entity 40, optional information 604 may be received from the UE, e.g., similar to optional information 503. Alternatively or in addition, optional information 603 may be received from the network 32, e.g., similar to optional information 504 of FIG. 4A. A monitoring entity in accordance with embodiments described herein may be configured for evaluating both, model 18 being operated at the UE 28 as described in connection with monitoring entity 40 and operated at network 32 as described in connection with monitoring entity 50. Said evaluation may be performed simultaneously or in a switching manner, i.e., sequentially. Further, the models 18 being operated at the UE 28 and/or the network 32 may relate to a same model or to different models, wherein models operated at the UE 28 may change or comprise more than one model as well as models operated at the device 32.

FIG. 5B shows a schematic flow chart of signals and/or actions similar to the illustration presented in FIG. 4B but relating to the configuration of FIG. 5A where the model 18 is operated on a network side, i.e., at the network 32. This may change the sources of information such that signals 601a, 601b and 601c exchange between the monitoring entity 50, and the network 32 may provide for a same or similar information for monitoring entity 50 when compared, for example, to monitoring entity 40 receiving signals 501a-c whilst signals 601a-c may be received from the network 32.

Similarly to signals 502a-b, the monitoring entity 50 may request measurement information for fault detection with a signal 602a from UE 28 and may receive, as a response, a report for fault detection with a signal 602b from UE 28.

The operation of the fault detection 34 may be in accordance with fault detection 34 being described in connection with FIG. 4B.

From network 32, there may be requested data for a fault diagnosis using a signal 603a transmitted from the monitoring entity 50 to the network 32 which may result in a signal 603b received from the network that provides data for the fault diagnosis.

Signals 604a-b may correspond to signals 503a-b and may allow to obtain measurement reports for the fault diagnosis at the monitoring entity 50. It is to be noted that the request 503a/604a may be transmitted to the UE 28 but also to a different entity performing measurements such that the report received with signal 503b or 604b may also be received from a UE not operating the model, refer to FIG. 4B, but a different entity not shown.

With a signal 605, the monitoring entity 50 may provide a monitoring report to the network. Such a report may be requested by use of a signal 606a from the monitoring entity 50 from UE 28 and may be provided to the UE 28 using a signal 606b as an alternative or in addition to a network specific configuration 606c provided to the UE 28. Such information contained in signals 606b and/or 606c may optionally be transmitted to network 32 to assist network configuration or re-configuration.

That is, as described in connection with FIGS. 4A-B, the model 18 may be used at a UE 28. Alternatively or in addition, a same or different model relating to the same or a different function/service may be operated at the network 32 such as a base station, BS/gNB and/or a core management function as described in connection with FIGS. 5A-B.

In other words, embodiments may relate to a monitoring operation, a diagnosis and/or an analysis.

### Monitoring Operation

The monitoring entity may provide a monitoring session, to monitor the behavior of a model such as a trained AI/ML model based on the model input or output data and/or additional information from the UE and the Network to obtain a fault indication being mapped on a detected fault, the fault indication characterizing the behavior of the AI/ML model.
The monitoring entity may provide a fault detection function to detect fault indication(s)
   Module operation based on Fault detection types
   Use positioning/beam management, BM, use case specific side-information or operation
The monitoring entity may provide a fault diagnosis function process the fault indication(s) and determine if indeed a Fault is present and what is the Fault type
   Module operation based on Fault detection types
   Use positioning/BM use case specific side-information or operation
The monitoring entity may provide a monitoring of specific side-information, signaling and measurements
   Configuration
   Association between the inference input/output and monitoring input/output
One relevant aspect/difference with prior work, is the Fault Diagnosis component, that tries to identify the root cause of the problem and recommend appropriate handling.
Another relevant aspect/difference with prior work, is that the Fault Diagnosis component, can request further information from the network and measurements from the UE to help identify the root cause of the problem.
Another relevant aspect/difference with prior work, is the combination of several information points, herein referred to as Fault Detection Analytics to provide as much information possible to the Fault Diagnosis component about the indication of fault.
Another relevant aspect/difference with prior work, is that the Fault Detection component can request further information from the network and measurements from the UE to compile a comprehensive list of fault indicators to the Fault Diagnosis module.
Another relevant aspect is that the proposed method/sequence of logical steps, can be instantiated to address all aspects of AI/ML-enabled positioning, beam management and CSI compression use cases.
Some NW/UE aspects relate to
   Map for monitoring specific issues in the monitoring method claim
   Describe signaling UE/gNB/core specific
      use case specific when needed
   signaling of parameters to configure the evaluation of the model and/or signaling results of the evaluation

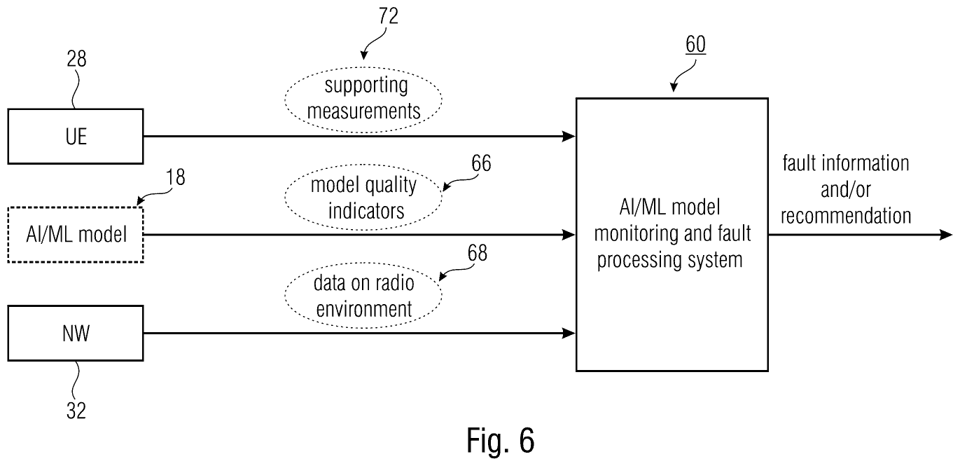

FIG. 6 shows a schematic block diagram indicating sources of information of a monitoring entity 60 according to an embodiment, which may be the monitoring entity 30, 40 and/or 50. The AI/ML model 18 may be operated at the UE 28, the network 32 or a different entity or a set of entities. Along with the model 18, there may be known, defined or provided model quality indicators or performance indicators from performance diagnosis modules 66. Whilst the network 32 may provide for data or information 68 relating to the radio environment of the wireless communication system, e.g., transmitted with a respective signal as well as performance indicators, the UE 28 may provide for supporting measurements or measurement reports 72, e.g., using signals 503b and/or 604b.

An AI/ML model monitoring and fault processing system as illustrated, for example, in FIGS. 4A and 4B, may lead to the possibility to indicate fault information and/or a recommendation, e.g., by implementing step 52, i.e., to provide information such as signals 505c and/or 606c.

The AI/ML Model Monitoring and Fault Processing system 60 which may be the monitoring entity 30, 40 and/or 50 is responsible for evaluating the performance of the deployed AI/ML model 18 during inference and provide feedback and suggested actions in case this performance degrades. According to an embodiment, it comprises of the Fault Detection Function 34, which is responsible to assess if there are signs of reduced AI/ML model performance (called Fault Indicators) and the Fault Diagnosis Function 44, which aims at identifying the root cause of the problem and propose actions to address it.

To achieve this, the Monitoring component or entity 60 has access to the input data and/or the outputs of the AI/ML model during inference. These could be the raw data or post-processed data statistics, such as mean and variance, as well as specialized model outputs like prediction uncertainty. To analyse further the available data and reason about potential AI/ML model performance problems, the Monitoring module can additionally utilize information from the Network side and request measurements from the UE side, at any point of the Fault Detection and Diagnosis process. This input contains targeted, relevant information from other network components, that can indicate a problem that can affect the performance of the AI/ML model.

Further, a configuration input is provided by the network, that determines specific conditions and operational thresholds that are utilized to distinguish between normal and degraded AI/ML model performance.

### The Monitoring Module Components

According to an embodiment, a Fault may be considered or defined to be a system failure or a change in the radio environment that leads to reduced performance for the AI/ML model, which in turn can lead to a reduction in QoS. For example, this may consider to apply an AI/ML model of a specific ID, e.g., a logical model, and/or of a specific implementation, e.g., a physical model, in a specific radio environment that is for any reason far from or mismatching the training data of the model which may lead to low performance or erroneous results of the model usage.

Embodiments may comprise two possibly main functional components to detect indicators of common faults and-when possible-to identify the root cause (the fault itself) and provide suggested actions to reduce its impact to the overall system performance:
The Fault Detection functionality 34: this observes and records specific aspects of the AI/ML model to detect signs of degrading performance (Fault Indicators). Once such a sign is detected (e.g., the input data statistics in Inference are different compared to the statistics of the training data), an alarm is raised, and all the relevant data are forwarded to the Fault Diagnosis module.
The Fault Diagnosis functionality 44: once a Fault Indicator is detected and an alarm is raised from the Fault Detection Functionality, this component is responsible to determine the potential type of the Fault (root cause), by analysing the relevant Fault data, along with relevant data from: i) other analytics of the Fault Detection module; ii) potentially additional measurements from the UE; and iii) additional information from the NW. If a Fault is indeed detected but the nature of the Fault cannot be determined, the system switches to a safe, fallback state 48 (for example utilizing a classical algorithm instead of the AI/ML model). The output of this module is a monitoring report, see signals 505b and 506/605 and 606b along with a recommendation on further actions needed (e.g., collect more data to fine-tune the model), see signals 505c and 606c.

As relevant data it may be understood, for example,
1. The specific alarm raised and the associated fault indicator.
2. The data/information from other Fault Detection analytics that check other aspects of the AI/ML model. For example, if an alarm about something in the input data is raised, but no fault indication on the output data was detected, this information is also provided to the Fault Diagnosis component.

Such an evaluation may allow to determine an indicator indicating the presence of a fault. Such a fault indictor may trigger a diagnosis that may determine a root cause causing the fault. Optionally, e.g., in knowledge of the root cause, a counter measure may be presented. However, knowledge of the root cause is not obligatory, e.g., as the awareness about the fault may already cause some predefined actions, e.g., switch to a default operation or fallback mode, regardless which reason the fault has. For example, the fault might be interpreted as the model operation being erroneous and the measure may be—without classifying the fault—to switch to a predefined different model or to stop use this or any model. As the action may but is not required to rely on the classification, it may already be of advantage to provide the root cause information, e.g., to allow a different entity to determine a necessity of a counter measure and/or the counter measure itself.

The monitoring report may include one or more pieces of information. For example, a generated Monitoring Report may provide information about one or more of.
A monitoring on the “score” of the diagnosis (a score on the quality of the model under this monitoring session)
A general monitoring metric associated with Functionality ID (e.g., for logical models)
Optionally: Identified problem and action
A specific monitoring metric Fault analytic ID score; certainty/probability (there could be 2 or more probable Fault Types/Root Causes, so the Monitoring could report which one is more probable).
A time information associated with one or more fault indications.

Alternatively or in addition, e.g., as additional information, the monitoring report may comprise information indicating
A model ID or Functionality ID if applicable, e.g., model based life cycle management, LCM, vs functionality based LCM
A model information (maybe only for open-format models), e.g., proprietary versus open source models
A configuration: applied threshold (maybe only for open-format models), e.g., a detailed monitoring configuration such as input data versus training data “distance”
A side information on the Quality of Service, which assisted to determine the Monitoring Metric/“Score”, i.e., for an example proprietary model, i.e., functionality-based LCM, one or more proxies for monitoring, e.g., performance versus required performance can be used.

Such a monitoring metric may be determined by the monitoring entity based on the evaluation result. The monitoring metric may be associated with, according to some embodiments, a model inference output. For example, the inference output may indicate a selected beam, a codebook or entry thereof, a position, combinations thereof and/or others. The monitoring may provide information on how the fault information is associated with the output.

Optionally, e.g., as an additional functionality:
If the monitoring proposes an action, follow-up and see if this action improved the problem (so in the future we can propose similar actions that we know worked in the past, in similar situations)

For example, if the root cause of the fault is determined, the recommendation or action indicator may be easily derived. For example, an action might be to switch from the current (e.g., a line-of-sight, LOS, only) model to a different model, e.g., a model that works for a mixed LOS/Non-LOS environment. However, the indication that a fault is presence may already be beneficial even if having not yet determined a possible counter measure.

FIG. 7 shows a schematic block diagram of a possible implementation of the fault detection module 34 according to an embodiment. Fault detection 34 may comprise one or more analyser modules 22₁ to 22_{N} that may also be referred to fault detection analytics. Signals 501a-b, 601a-b, 501c, 601c, 502 and 602 show information that may be received when operating the fault detection module 34 as a monitoring entity evaluating the model 18 being operated at the UE, the network respectively as described in connection with FIGS. 4A-5B. The fault detection module 34 may provide for the performance indicator or fault indicator 36 indicating that one or more or even that a specific analyser module 22₁ to 22_{N} has determined a possible fault or low performance for the criterion examined by the analyser module 22.

### The Fault Detection Module 34

This module comprises from a set of Fault Detection Analytics, each of which potentially observes and records specific aspects of the AI/ML model during inference. Specifically, different analytics that detect AI/ML model concept drift focusing either on the model input (501a, 601a) or output (501b, 601b) are deployed. In several cases, a comparison between the input/output data statistics during Inference and the input/output data statistics during model training is used. If mismatch above a threshold occurs, a Fault Indicator is generated. The statistics of the training data, as well as the threshold values for each analytic, are unique for each AI/ML model and are provided as configuration information (501c, 601c) in the respective Fault Detection Analytics.

For example, each fault detection analytic module or analyser module may verify or evaluate a presence of a specific fault, e.g., a mismatch, a presence or use of a wrong model, a model drift or the like. Alternatively or in addition, a specific fault or problem may be evaluated with a set of more than one analyser module, e.g., using different parameters of the evaluation and/or dividing a fault into a set of partial faults, each of which is evaluated with an analyser module to arrive at partial results that may be combined or regarded individually.

Several analytics can utilize additional information from the NW (502) or the UE (602), depending on whether the AI/ML model is deployed in the UE or the NW respectively. This information can stem from the beam codebook configuration and relative device rotation for the UE, to monitoring the QoS in the NW side to determine AI/ML model degradation, in case the QoS drops. Further possible information includes transmit beam and/or receive beam spatial information;

information related with the one or more resource(s) or resource set(s); information related with the differential information between one or more resource(s) or/and resource set(s) and/or frequency layers and/or TRPs. Alternatively or in addition such additional spatial information may relate to a Tx/Rx beam information, in case a UE performs a selection transparent to the network. Information on resources can include power values, or expected value(s) or statistics associated with one or more resources. Similarly, the information can be differential between multiple resources which can be from multiple TRPs or multiple beams of the same TRP. One example is the expected value or power difference between the two or more resources

As an aspect or set of parameters to be observed and/or recorded by the modules, one may understand that each analytic focuses on different points that could indicate performance degradation of the AI/ML model. For example:
Analytic #1: checks if the mean and variance of the input data are within the same limits (within a certain threshold) compared to the main and variance of the training data
Analytic #2: checks if the AI/ML model outputs are within the acceptable limits
Analytic #3: checks if the model output changes unreasonably with time (between time-steps). For example: the UE appears to “teleport” within time-steps . . .

To focus may have a similar meaning when compared to relating to an aspect of the overall situation. For example, when considering the AI/ML model as a “black box” that performs some calculations, the inputs and the outputs of the model depend on its functionality. By way of example:
A model for beam management could take as inputs the beam IDs measured by the UE the last X time steps and the RSRP (a value measured by the UE that shows how good each of these beams serve the UE) values of these beams and give as output a set of 5 new beams for the UE to measure (that would hopefully have higher RSRP).
A model for positioning could take as input the CSI from 3 Base Stations and provide as output a 3D point, which is the estimate of the position of the UE.

When referring to “focus” is relates to a similar as the “aspect” above. The analytics focus on the input signal, this may mean that the analytics focusing (e.g., only) checking the AI/ML model input for Fault Indicators

Naturally, the outputs of several Fault Detection Analytics can be combined in a hierarchical manner to determine the existence of a Fault Indication with higher probability.

The hierarchical manner may relate to different aspects or parameters of the faults to be sorted or regarded hierarchically. For example, the analysers (fault detection analytics) may examine each the data for a predefined fault (e.g., yes/no), to indicate if a respective fault is present. The faults may be sorted according to a hierarchy, e.g., a most important fault resulting in a counter measure or root cause analysis, or determining an amount or share of the root cause or mitigation thereof in a found solution. Alternatively or in addition, from the detected faults, some may be more significant than others, e.g. as some have minor mismatches and others severe mismatches. That is, the amount of mismatch may at least partially contribute to the hierarchy. A combination of both considerations is possible, e.g., using a weighted combination based on weights. The Fault Diagnosis may be used to try to find the root cause of the problem. That may be one of the main functionalities. Then, based thereon, the present solution can recommend an action/counter measure to be taken.

For example, a plurality of analytics i.e., analyser modules and/or performance diagnosis modules may be used

In one example, a plurality of analytics may be combined with different importance weights or confidence levels. For example:
Fault indications raised from input/output data statistics are less representative of a fault compared to alarms raised from model prediction accuracy analytics. These, in turn, can be overruled by system performance analytics.
When comparing to the “true” model label (e.g., the “true” 3d position for positioning or the best beam for beam management), different approaches to generate these true labels/reference data have different validity conditions, quality or confidence intervals. For example:
   For the true label quality of beam management approaches: measure all beams in codebook>use a more complex and accurate AI/ML model for beam management>assume the best beam is the same beam determined by other UEs in proximity
   For the true label quality of positioning approaches: PRU>more complex and accurate AI/ML algorithm (e.g., at the LMF)>positioning using landmarks>sidelink positioning>non-RAT methods

In another example, that may be combined with the earlier or may form an alternative, the plurality of analyser modules in the monitoring entity comprises a set of modules that evaluate the combined performance of the AI/ML model under different monitoring dimensions, based on key performance indicators (KPIs). These KPIs can include accuracy, confidence, latency, generalization, and other relevant metrics.
Out of distribution (OOD) analyser: This module determines if the AI/ML model input/output data statistics are close to the training data distribution.
Prediction Accuracy Analyser: This module assesses the performance of the AI/ML models by comparing their performance metrics, such as accuracy, precision, recall, or F1 score, against a state-of-the-art baseline. It helps determine how well the models perform in terms of their predictive capabilities.
System performance analyser: this module has access to KPIs that are related to aspects of QoS for the network (e.g., link quality KPIs for beam management applications). It helps determine if a QoS/system performance threshold set by a higher layer is achieved.
Latency Analyser: This module evaluates the inference latency of the AI/ML models. The latency is compared against desired thresholds or benchmarks to ensure the models meet the real-time requirements of the application.
Complexity/Overhead Analyser: This module analyses the computational complexity of the AI/ML models. It considers factors such as processing power, memory usage, and algorithmic complexity. By comparing the computational complexity against a baseline, it helps identify models that are more efficient in terms of resource utilization, thus providing insights into the additional resources needed for deploying and maintaining the AI/ML models.

Based on this, a set of examples is provided where the output of more than one monitoring metrics are advantageously combined:
The OOD analyser indicates that input data statistics are far from the training data, but the prediction accuracy analyser indicates that the model is still accurate, so no fault is present.
The prediction accuracy analyser indicates that the model's prediction accuracy is high, but the latency analyser determines that latency violates the required constraint/threshold, thus the model might no longer be suitable for use.
The prediction accuracy analyser indicates that the model's prediction accuracy is low, but the system performance analyser indicates that QoS/system performance threshold set by the NW is fulfilled, so no reason to mark this situation as a Fault.

Once a Fault Indication is detected the specific Indication (type), as well as all relevant information from all relevant Fault Detection Analytics are forwarded to the Fault Diagnosis function. A fault Indication may relate to inference input and training data mismatch or other lack of performance.

The inference model is trained using real-world or simulation data drawn from a specific data distribution. The fault detection in the monitoring entity can implement analytics that identify if the inference input data follows the same distribution or there is a case of AI/ML model concept drift. To achieve this, the inference model input is monitored for a pre-defined time window (configuration) and if in this window there is a mismatch above a certain threshold (configuration) a fault indication alarm is raised and forwarded to the Fault Diagnosis Entity.

In one aspect, the monitoring modules evaluates measurements (RSRP, RSTD, Tx-Rx, RSRPP, RToA, RSSI) on the model input resources. The measurements being associated with the inference input or an inference output. The monitoring module utilizes plurality of the measured values to determine if the inference input differs from the training data. In one example, a measured RSRP values/pattern for the initial set of beam measurements during inference differs from training data.

Similarly, the monitoring modules evaluates information derived from measurements (CQI, RI, position, beam selection) associated with the inference input or inference output. Wherein the monitoring utilizes plurality of the measured value(s).

In a related aspect, the monitoring module requests measurements or information derived from measurements or plurality of measurements to determine if the inference input differs from the training data. In some examples, channel characteristics such as ground reflections or antenna radiation impact due to hand blockage or the Fraunhofer distance. Such aspects are often not well modeled due to the low probability of occurrence or due to its complexity. Related to this example, near reflection such as ground reflections, the performance of the positioning estimators is degrades noticeably. For ML, either the model is trained on this effects or the model is not trained (explicitly considering these effects). If the ML model is not trained on them then it might be possible to identify fault indication if such effects occur on the inference input.

### Fault Indication: Inference Output Inconsistency

The fault detection in the monitoring entity can implement analytics that identify indications of non-expected model outputs. Examples could be:

### EXAMPLE 1: BEAM MANAGEMENT, EX #1

Measured RSRP values in the beams predicted by the model are lower than expected

### EXAMPLE, 2: BEAM MANAGEMENT EX #2

a. Measured RSRP values in the beams predicted by the model are lower than expected
b. The AI/ML model predicts different spatially un-correlated beams between timesteps (beam ID hopping)
c. The AI/ML model starts predicting/suggesting faster beam changes

### EXAMPLE 3 POSITIONING

d. In case the model also reports its confidence levels, the predicted position has higher uncertainty
e. The last positions predicted by the model do not consist of a smooth trajectory (so typical human walking/running or vehicle movement)

### Fault Indication: Side Information on QoS

For at least some or even all Cases the following may apply:

The beam management or positioning AI/ML models are a component/entity in a larger pipeline associated with a final QoS for a specific Use Case (e.g., robotics guidance in a warehouse, telemedicine applications, whatevs). When the QoS drops, the validity of all components/entities (including the AI/ML model) needs to be double-checked

### Fault Indication: ML Model Drift

During the ML training several effects leads to model drifting as a result that these remains uncovered in the training phase. Such effects includes idealistic antenna patterns, assumptions for analog/digital or hybrid beamforming, behavior change due to aging or exchange of hardware components, un-calibrated setup lead to a model degradation which drifts over the observation interval. The fault detection model dismisses other fault sources for monitoring a model drift over an observation period.

### Side-Information

The monitoring entity can receive for this step information on the hardware grade (a low cost hot spot drifting performance differs from a macro base station, similar to high-end UE and low cost UEs) or setup information such as calibration level (for example coherent transmissions from multiple antenna elements or multi-panels or multi-TRPs).
Action diagnose step (related to next section) can be configured when to release an alarm
monitoring model shall receive information on an ML model “version”. If a monitoring entity is unaware of a model update “continuous” monitoring might be not reasonable. This is due to the fact that depending on the change impact of the ML model, the monitoring between different observations might not be possible or lead to wrong diagnosis.

FIG. 8 shows a schematic block diagram of the fault diagnosis module 44 showing a number of M performance diagnosis modules 66.

### The Fault Diagnosis Module 44

The Fault Diagnosis module receives the relevant information about a detected Fault Indication from the Fault Detection module and utilizes a specific set of Fault Diagnosis Analytics to process it and determine if indeed a Fault is present and what is the Fault type.

In this process, further measurements/information-that would enable pinpointing the root cause of the problem-from the NW and UE side can be requested (503/504/603/604). In a related aspect, the fault detection in the monitoring entity can receive side-information indicating measurement information or channel characteristics to assist or enable in identifying the fault. Wherein the side-information is associated with the inference input and wherein the monitoring is to apply this information to monitor a specific behavior or magnify on a certain effect. The side information can be an information related between pluralities of resources (such as quasi collocation information, transmission configuration, relative delay, hardware relates such timing error groups or antenna ports) or between pluralities of measurements (such as relative average power, relative average power on the first path, relative time delay). Additionally or alternatively, side information might include one or more indication information on identified relevant part for monitoring in the inference model. This can be particularly advantageous, if the entity providing side-information is aware of ML-Model drop in performance subject to a certain effect. For example, if an ML model performs poorly due to the occurrence of early reflections because the model is not trained on such effects, side-information indicating the reflection (blockage, . . . ) which can be inferred from the model input or statistics can assist in identifying the associated fault indication.

Also here, the outputs of several Fault Diagnosis Analytics can be combined in a hierarchical manner to determine the existence of a specific Fault. Different ways of implementing a hierarchy may be used, e.g., as described in connection with the anaylsers.

For example, the output of the Fault Diagnosis function can be one of three options:
There is no Fault present, or its presence does not affect the QoS;
There is a Fault in the process, but the Fault Diagnosis function cannot isolate the root cause of the problem. A fallback strategy should be applied;
There is a known Fault type detected. Recommendations (such as switch to different model type, monitor the AI/ML model in more frequent intervals, the AI/ML model is no longer valid and needs to be re-trained, etc.) to minimize its impact on the system performance are provided.

Finally, a monitoring report is compiled and provided both to the UE and NW sides for further processing. The report contains a detailed description of the monitoring process, the related input/output data of the AI/ML model along with additional measurements/data that were requested from the NW or UE-side.

### Fault Diagnosis: Inference Input and Training Data Mismatch

Fault Indication for beam management: may apply to at least some or even all positioning Cases
   a. Measured RSRP values/pattern for the initial set of beam measurements during inference differs from training data;
Fault Indication for positioning: may apply to at least some or even all positioning Cases
   a. Positioning accuracy is dropping (as indicated for example with comparing to true position provided by PRU);

### Fault Diagnosis Entity Possible Recommendations:

Example 1, Beam Management Ex #1: switch to classical approach/setback. For example, hierarchical or full beam search
Example 2, Beam Management Ex #2:
   a. Measure again as temporal effects might not be there anymore
   b. Measure again but for each TRP beam report values for all UE beams
   c. Make the prediction/inference and observe if a Fault Indication is also raised for the output statistics or QoS
Example 3, Positioning Ex #1:
   a. [Side Information]: if the UE was near the boundaries of a known “problematic” area, then assume it entered there and recommend a switch to a model trained for that area.
Example 4, Positioning Ex #2:
   a. [Side Information]: This can be particularly advantageous, if the entity providing side-information is aware of ML-Model drop in performance subject to a certain effect. For example if an ML model performs poorly due to the occurrence of early reflections because the model is not trained on such effects, side-information indicating the reflection (blockage, . . . ) which can be inferred from the model input or statistics can assist in identifying the associated fault indication.

### Fault Diagnosis: Inference Output and Expected Output

### Fault Diagnosis Entity Possible Recommendations Provided by the Entity:

Example 1, Beam Management Ex #1
   a. Fault Indication: Measured RSRP values in the beams predicted by the model are lower than expected
   b. Fault Diagnosis Entity Possible Recommendations:
      Do hierarchical or full beam search
      IF inference input monitoring did not raise an alarm, compare the best beams detected to the predicted AI/ML model output to have an indication of model validity
      IF model is bad, enable AI/ML model drift detection analytic, to evaluate long-term quality of the model.
Example 2, Beam Management Ex #2
   a. Fault Indication: Measured RSRP values in the beams predicted by the model are lower than expected
   b. Fault Diagnosis Entity Possible Recommendations:
      Repeat with different or all UE beams for measurements
      Switch to classical
      IF inference input monitoring did not raise an alarm, compare the best beams detected to the predicted AI/ML model output to have an indication of model validity.
      IF model is bad, enable AI/ML model drift detection analytic, to evaluate long-term quality of the model.
Example 3, Beam Management Ex #3
   a. Fault Indication: The AI/ML model predicts different spatially un-correlated beams between timesteps (beam ID hopping)
   b. Fault Diagnosis Entity Possible Recommendations:
      Repeat with different or all UE beams for measurements
      Switch to classical
      IF inference input monitoring did not raise an alarm, compare the best beams detected to the predicted AI/ML model output to have an indication of model validity
      IF model is bad, enable AI/ML model drift detection analytic, to evaluate long-term quality of the model.
Example 4, Beam Management Ex #4
   a. Fault Indication: The AI/ML model starts predicting/suggesting faster beam changes
   b. Fault Diagnosis Entity Possible Recommendations:
      [Side Information]: request movement information from the UE (maybe entered a car or a train and pattern changed)
      Potentially change to a model trained for high-velocity beam management
Example 5, Positioning Ex #1
   a. Fault Indication: In case the model also reports its confidence levels, the predicted position has higher uncertainty
   b. Fault Diagnosis Entity Possible Recommendations:
      Switch to a different model that has less uncertainty with the same measurements (input data).
Example 6, Positioning Ex #2
   a. Fault Indication: The last positions predicted by the model do not consist a smooth trajectory (so typical human walking/running or vehicle movement)
   b. Fault Diagnosis Entity Possible Recommendations:
      Request an estimation of the UE position using different method (e.g., PRU, side-link positioning, GNSS, etc.)

Another example can be associating a wide-beam measurement with high certainty than the associated one or more narrow beams. In this example, the monitoring entity can identify if a selected “optimum” beam is outside the expected region the fault indication can be further diagnosed.

### Fault Diagnosis: Side Information on QoS

If QoS drops significantly in a critical use case, operation switches back to a fallback mode and all possible aspects of the AI/ML model quality are monitored and reported.

### Fault Diagnosis: ML Model Drift

If a long-term monitored model (of any type) is identified as not being valid, an alarm is raised, and the model is deactivated.

The monitoring entity can identify the type of validity of the model. It can occur that the model is valid, however the validity is conditioned on a temporal or longer time interval. The validity can be associated with an area such an absolute/relative geographical area or spatial validity.

Signals 503, 504, 603 and 604 correspond to FIGS. 4A-5B whilst the fault diagnosis module 44 may receive optional information on fault indications 36 provided by or derived from the fault detection module 34. Signal 52 may contain a recommendation as described in connection with FIGS. 4A and 5A and/or may comprise a fault information that allows to derive such a recommendation at a different entity. For example, a fault diagnoses may be expressed as an alarm raised because of a mismatch between the model input data and training data. An applied monitoring metric may relate to a deviation of mean values of model input data from model training data. A threshold that may be applied may allow a deviation of the mean values to not exceed a value Z (e.g., expressed as a number). The alarm may be raised due to the fact that a deviation of mean values exceeds 1.5*Z.

In the following, additional embodiments and aspects of the invention will be described which can be used individually or in combination with any of the features and functionalities and details described herein.

A first aspect relates to a monitoring entity for an AI/ML model used in a wireless communication system, wherein the monitoring entity is configured to: receive model data associated with the model; execute an evaluation of the model data, using a plurality of analyser modules of the monitoring entity, wherein each analyser module is configured for evaluating an associated set of parameters derived from the model data with respect to an evaluated property to determine an associated monitoring metric associated with the analyser module, the associated monitoring metric indicating a performance of the model with respect to the evaluated property; and wherein the monitoring entity is adapted to request, from a different network entity, e.g., UE/NW additional information relating to the model; and to use the additional information relating to the model for obtaining the plurality of associated monitoring metrics.

According to a second aspect when referring back to the first aspect, the monitoring device is adapted to execute the evaluation with respect to reference model data to obtain an evaluation result for the model data.

According to a third aspect when referring back to the first or second aspect, the evaluation result for the model data is based on at least one of the plurality of associated monitoring metrics.

According to a fourth aspect when referring back to any of the first to third aspects, the evaluation result and/or at least one associated monitoring metric comprises a performance characteristic of the AI/ML model.

According to a fifth aspect when referring back to the fourth aspect, wherein the performance characteristic indicates a fault of the AI/ML model.

According to a fifth aspect when referring back to any of the previous aspects, the monitoring entity is to: combine the plurality of associated monitoring metrics to obtain a combined monitoring metric that forms at least a basis for an evaluation result for the model data; and/or select one of the plurality of associated monitoring metrics to form a basis for an evaluation result for the model data.

According to a seventh aspect when referring back to the sixth aspect, the monitoring entity is configured to select one of the plurality of associated monitoring metrics to form a basis for the evaluation result based on a hierarchical order of the analyser modules or of the associated monitoring metrics.

According to an eighth aspect when referring back to any of the previous aspects, at least one analyser module is adapted to evaluate the associated set of parameters with respect to be in accordance with a predefined parameter range.

According to a ninth aspect when referring back to any of the previous aspects, the additional information relates to at least one of:
information obtained from a beam codebook configuration;
transmit beam and/or receive beam spatial information;
information related with one or more resource(s) or resource set(s);
information related with the differential information between one or more resource(s) or/and resource set(s) and/or frequency layers and/or TRPs;
a relative device rotation for a device forming a beam; and
a QoS parameter monitored at a network side.

According to a tenth aspect when referring back to any of the previous aspects, for determining the associated monitoring metrics, the plurality of analyser modules is configured to evaluate measurements on resources of the wireless communication system in which the model is operated, the measurements associated with an input and/or output of a model inference to determine the associated monitoring metric; and/or to evaluate values derived from the measurements on the resources to determine the associated monitoring metric.

According to an eleventh aspect when referring back to any of the previous aspects, the monitoring entity is adapted to determine, based on the monitoring metric, a root cause information indicating a root cause of a match or mismatch between an observed behaviour of the AI/ML model and a modelled behaviour of the AI/ML model and to provide the monitoring metric to indicate the match or mismatch.

According to a twelfth aspect when referring back to the eleventh aspect, the monitoring entity is adapted to provide the root cause information.

According to a thirteenth aspect when referring back to the eleventh or twelfth aspect, the monitoring entity is adapted to determine, based on the monitoring metric and/or the root cause information, an action indicator indicating a counter measure to encounter the mismatch; wherein the monitoring entity is configured to provide the output signal to indicate the action indicator.

According to a fourteenth aspect when referring back to any of the eleventh to thirteenth aspects, the monitoring entity is configured to classify the mismatch to correspond to one of a set of predefined types of performance characteristics, e.g., faults, and to provide the action indicator to indicate the counter measure based on the corresponding type of performance characteristic.

According to an fifteenth aspect when referring back to the fourteenth aspect, the monitoring entity is configured to determine the mismatch to not correspond to the set of predefined types of performance characteristics and to provide the action indicator to indicate the counter measure as a fallback operation for a device using the model.

According to a sixteenth aspect when referring back to any of the thirteenth to fifteenth aspects, the counter measure comprises, e.g., in a case where the monitoring entity operates for a network-side monitoring:
an indication to activate a functionality or model;
an indication deactivate a functionality or model;
an indication to switch a functionality or model; and/or
an indication to operate according to a predefined fall back option

According to a seventeenth aspect when referring back to any of the thirteenth to sixteenth aspects, the counter measure comprises, e.g., in a case where the monitoring entity operates for a UE-side monitoring, an update on supported model functionalities.

According to an eighteenth aspect when referring back to any of the previous aspects, the monitoring entity is configured to determine a root cause information indicating a root cause of a performance lack and to provide the root cause information and/or to use the root cause information to mitigate the root cause; wherein the monitoring entity is to determine, based on the root cause information a counter measure to encounter the mismatch to mitigate the root cause; wherein the monitoring entity is configured for determining the counter measure as a use of a different model and/or a different state of the model.

According to a nineteenth aspect when referring back to any of the fortieth to forty-first aspects, the monitoring entity is adapted to receive side-information indicating measurement information or channel characteristics and to process the side-information to identify a performance characteristic causing the mismatch; wherein the wherein monitoring entity is adapted to determine the counter measure based on the identified performance characteristic to encounter the performance characteristic.

According to a twentieth aspect when referring back to the nineteenth aspect, the side-information is associated with an inference input of an inference of the model and wherein the monitoring entity is to apply the side information to monitor a specific behavior or magnify on a predefined effect associated with the model.

According to a twenty-first aspect when referring back to the nineteenth or twentieth aspect, the side information comprises an information
related between pluralities of resources;
between pluralities of measurements performed in the wireless communication system; and/or
one or more indication information on an identified relevant part for monitoring the model.

According to a twenty-second aspect when referring back to any of the eighteenth to twenty-first aspects, the monitoring entity is to determine the counter measure so as to indicate one of
keep the current state of the model, e.g., as its presence does not affect the QOS;
a recommendation such as a switch to a different type of the model, to monitor the AI/ML model in more frequent intervals, to indicate that the AI/ML model is no longer valid and needs to be re-trained, to reduce or minimize an impact of the detected and known performance characteristic on the system performance;
to switch to a fallback strategy;
an indication to activate a functionality or model;
an indication deactivate a functionality or model;
an indication to switch a functionality or model;
an update on supported functionalities and/or
an indication to operate according to a predefined fallback option.

According to a twenty-third aspect when referring back to any of the previous aspects, the monitoring entity is to generate and provide a monitoring report to is compiled and provided to the wireless communication system, the monitoring report comprising information indicating the monitoring process, the related input/output data of the model and/or additional measurements/data that were requested from the NW or UE-side.

According to a twenty-fourth aspect when referring back to the twenty-third aspect, the monitoring entity is adapted to provide the monitoring report as a predictive report; and/or to include into the monitoring report a predictive counter measure to indicate information of one or more expected future monitoring metrics in the wireless communication system.

According to a twenty-fifth aspect when referring back to the twenty-third or twenty-fourth aspect, the monitoring entity is adapted to provide the monitoring report as a long period monitoring and to evaluate the AI/ML model or the monitoring metric during multiple time instances to obtain a plurality of results; wherein the monitoring entity is adapted to generate the monitoring report as a long-period report or a long-period counter measure indication to mitigate a root cause of the monitoring metric.

According to a twenty-sixth aspect when referring back to the twenty-fifth aspect, the monitoring entity is adapted to identify a similarity between results of different time instances and to provide for a common counter measure for mitigating a root cause of a group of similar monitoring metrics based on the similarity and/or to group the results based on the similarity in the monitoring report.

According to a twenty-seventh aspect when referring back to any of the previous aspects, the monitoring entity is adapted to request, for monitoring the AI/ML model, additional information that indicate at least one of parameters to be measured for the monitoring, a setting for the measurement and details about a report to be provided based on the monitoring.

According to a twenty-eighth aspect when referring back to any of the previous aspects, the monitoring entity is adapted to determine, based on the evaluation, a monitoring metric associated with a functionality of the AI/ML model, e.g., represented as an functionality ID and to report the monitoring metric to the wireless communication system, e.g., using a monitoring report.

According to a twenty-ninth aspect when referring back to the twenty-eighth aspect, the monitoring entity is adapted to include, into the monitoring report, information a root cause information indicating a root cause of the performance characteristic and/or a counter measure information indicating a counter measure to mitigate the root cause.

According to a thirtieth aspect when referring back to the twenty-eighth or twenty-ninth aspect, the monitoring device is adapted to include at least two interpretations of the evaluation result, e.g., at least two monitoring metrics, at least two monitoring metrics and/or at least two counter measure information into the monitoring report and an associated information indicting at least one of a scoring, a probability or certainty for associated with the interpretations.

According to a thirty-first aspect when referring back to any of the previous aspects, the monitoring entity is configured for a model inference of the AI/ML model; and/or wherein the reference model data indicates an expectation of the model data and/or an expectation of model performance during operation.

According to a thirty-second aspect when referring back to any of the previous aspects, the monitoring entity is configured for determining the evaluation result to comprise a performance characteristic diagnosis information indicating a performance characteristic type of the performance characteristic, e.g., a fault.

According to a thirty-third aspect when referring back to any of the previous aspects, the the AI/ML model is a single side or two-sided AI/ML model.

According to a thirty-fourth aspect when referring back to any of the previous aspects, the AI/ML-model models a modelled behaviour in the wireless communication system, wherein the monitoring entity is configured to evaluate the model based on the model data and the reference model data to determine a match or a mismatch between the modelled behaviour and the modelled behaviour.

According to a thirty-fifth aspect when referring back to any of the previous aspects, the monitoring entity is configured for determining the evaluation result to indicate a performance of an AI/ML model inference.

According to a thirty-sixth aspect when referring back to any of the previous aspects, the AI/ML-model models a modelled behaviour in the wireless communication system, wherein the monitoring entity is configured to: determine a mismatch between an observed behaviour and the modelled behaviour and to provide the monitoring metric to indicate the mismatch.

According to a thirty-seventh aspect when referring back to any of the previous aspects, the monitoring entity comprises: a plurality of analyser modules, wherein each analyser module is configured for evaluating an associated set of parameters derived from the model data with respect to an evaluated property to determine an associated monitoring metric associated with the analyser module, the associated monitoring metric indicating a performance characteristic of the model with respect to the associated set of parameters.

According to a thirty-eighth aspect when referring back to any of the previous aspects, each of the plurality of analyser modules is configured to observe and evaluate an associated aspect of the modelled behaviour during a model inference of the AI/ML model.

According to a thirty-ninth aspect when referring back to any of the previous aspects, at least one analyser module of the plurality of analyser modules is adapted to evaluate a model input provided by a network entity operating the model to determine a mismatch between a model output expected based on the model input and an observed behaviour relating to the model.

According to a fortieth aspect when referring back to any of the previous aspects, at least one analyser module of the plurality of analyser modules is configured to evaluate the associated set of parameters based on a comparison between values of the set of parameters such as input/output data statistics, obtained during a model inference of the AI/ML model on the one hand and values of the set of parameters obtained during a training of the model on the other hand.

According to a forty-first aspect when referring back to the fortieth aspect, the monitoring entity comprises a memory having stored thereon the values of the set of parameters obtained during the training of the model.

According to a forty-second aspect when referring back to the fortieth or forty-first aspect, the values of the set of parameters relate to statistics of the set of parameters.

According to a forty-third aspect when referring back to the forty-second aspect, the monitoring entity is configured to determine the monitoring metric based on a deviation between a first statistical value related to the set of parameters obtained during the model inference and a second statistical value related to the set of parameters obtained during the training of the model, the deviation exceeding a predefined threshold value.

According to a forty-fourth aspect when referring back to any of the previous aspects, the monitoring entity is configured to provide the monitoring metric to indicate a type of mismatch between an observed behaviour and the modelled behaviour and associated information of one, a set or all of a plurality of analyser modules to determine the action indicator, each analyser module configured for evaluating an associated set of parameters derived from the model data with respect to an evaluated property to determine an associated monitoring metric associated with the analyser module, the associated monitoring metric indicating a performance characteristic of the model with respect to the associated set of parameters.

According to a forty-fifth aspect when referring back to any of the previous aspects, the monitoring entity is adapted to: receive the model data to comprise input data of the model and to compare an expected behaviour of the model responsive to the input data of the model with an observed behaviour of a device that uses the model; and/or receive the model data to comprise output data of the model and to compare an expected behaviour of the model responsive to the output data of the model with an observed behaviour of a device that uses the model.

According to a forty-sixth aspect when referring back to any of the previous aspects, the monitoring entity is adapted for a model inference of the model for a configured predefined time window and to determine that within predefined time window a mismatch between the observed behavior and the model data is above a predefined threshold to determine the monitoring metric.

According to a forty-seventh aspect when referring back to any of the previous aspects, the monitoring entity is configured for providing the monitoring metric as indicating an output-inconsistency of a model inference of the AI/ML model.

According to a forty-eighth aspect when referring back to the forty-seventh aspect, the monitoring entity is configured for determining the output-inconsistency based on analytics that identify indications of non-expected model outputs.

According to a forty-ninth aspect when referring back to the forty-eighth aspect, the output-inconsistency relates to a statistical distribution of RSRP values of beams generated by a device using the model is different than indicated in the reference model data.

According to a fiftieth aspect when referring back to any of the forty-seventh or forty-eighth aspect, the output-inconsistency relates to a result of the evaluation that the model predicts different spatially un-correlated beams between timesteps, e.g., a beam ID hopping

According to a fifty-first aspect when referring back to any of the forty-seventh to forty-eighth aspects, the output-inconsistency relates to the model to change a speed of suggested beam changes

According to a fifty-second aspect when referring back to any of the forty-seventh to fifty-first aspects, the output-inconsistency relates to a decrease of a quality of service, QoS, provided by a device using the model.

According to a fifty-third aspect when referring back to any of the forty-seventh to fifty-second aspects, the output-inconsistency relates to a drift of the model.

According to a fifty-fourth aspect when referring back to any of the forty-seventh to fifty-third aspects, the monitoring entity is to receive and process information indicating at least one of a hardware or setup of the device using the model and information indicating a version of the model to obtain the evaluation result.

According to a fifty-fifth aspect when referring back to any of the previous aspects, the monitoring entity is configured to determine a root cause information indicating a root cause of a performance lack and to provide the root cause information and/or to use the root cause information to mitigate the root cause.

According to a fifty-sixth aspect when referring back to the fifty-fifth aspect, the monitoring entity is configured to determine a mismatch between a behaviour and a modelled behaviour predicted by the model and to provide the monitoring metric to indicate the mismatch; and to determine the root cause information based on the monitoring metric.

According to a fifty-seventh aspect when referring back to any of the fifty-fifth or fifty-sixth aspect, the monitoring entity is adapted to determine, based on the root cause information an action indicator indicating a counter measure to encounter the mismatch to mitigate the root cause.

According to a fifty-eighth aspect when referring back to the fifty-seventh aspect, the monitoring entity is adapted to determine the performance characteristic of the model to relate to measured RSRP values of beams generated by a device using the model are lower than indicated in the reference model data; and to determine the counter measure as an indicator to perform a hierarchical or full beam search.

According to a fifty-ninth aspect when referring back to the fifty-seventh or fifty-eighth aspect, the monitoring entity is adapted to determine that the performance characteristic is unrelated to inference input monitoring, and to determine the counter measure as an indicator to compare best beams detected to the predicted AI/ML model output to have an indication of model validity.

According to a sixtieth aspect when referring back to the fifty-ninth aspect, the monitoring entity is adapted to determine the counter measure as an indicator to enable AI/ML model drift detection analytic, to evaluate long-term quality of the model based on a determined model invalidity.

According to a sixty-first aspect when referring back to any of the fifty-seventh to sixtieth aspects, the monitoring entity is adapted to determine the performance characteristic of the model to relate to at least one of:
measured RSRP values of beams generated by a device using the model are lower than indicated in the reference model data;
the model predicting different spatially un-correlated beams between timesteps, e.g., abeam ID hopping;
and to determine the counter measure as an indicator to at least one of:
repeat with different or all device beams for measurements
Switch to a classical or predefined mode, e.g., to perform a hierarchical or full beam search.
In case an inference input monitoring did not raise an alarm, to compare best beams detected to a predicted AI/ML model output to have an indication of model validity; and in case the model lacks validity, enable AI/ML model drift detection analytic, to evaluate long-term quality of the model

According to a sixty-second aspect when referring back to any of the fifty-fifth to sixty-first aspects, the monitoring entity is configured to request further measurement results or information related to a root cause of the performance characteristic from the wireless communication system or a specific entity, e.g., a UE.

According to a sixty-third aspect when referring back to any of the fifty-fifth to sixty-second aspects, the monitoring entity comprises a plurality of detection modules configured to determine, based on the monitoring metric or a performance characteristic determined by the detection modules and optionally based on side information, a plurality of detector results, each detector result indicating a result whether a specific performance characteristic of the model is detected or indicating a likelihood of the specific performance characteristic, wherein the specific performance characteristic is associated with the root cause information.

According to a sixty-fourth aspect when referring back to the sixty-third aspect, the monitoring entity is to: combine the plurality of detector results to obtain a combined detector result that forms at least a basis for a selection of the counter measure; and/or select one of the plurality of detector results to form a basis for the counter measure.

According to a sixty-fifth aspect when referring back to the sixty-fourth aspect, the monitoring entity is configured to select one of the plurality of detector results to form a basis for the counter measure based on a hierarchical order of the detector modules or of the associated detector results.

According to a sixty-fifth aspect when referring back to the fifty-fifth to sixty-fifth aspects, the monitoring device is adapted to determine the root cause or a counter measure to mitigate the root cause less frequent when compared to determining the monitoring metric.

According to a sixty-seventh aspect when referring back to the fifty-fifth to sixty-sixth aspects, the monitoring device is adapted to request, at the wireless communication system, a processing gap for the monitoring and to perform the monitoring during the processing gap.

According to a sixty-eighth aspect when referring back to the fifty-fifth to sixty-seventh aspects, the monitoring device is adapted to determine the counter measure from a counter measure previously determined for a similar or same root cause or monitoring metric.

According to a sixty-ninth aspect when referring back to the fifty-fifth to sixty-eighth aspects, the monitoring device is adapted to obtain information about an effect of the counter measure, e.g., a success or fail or a degree of change, to obtain a performance result and to determine subsequent counter measures based on the performance result, e.g. at least for similar monitoring metrics.

According to a seventieth aspect when referring back to any of the previous aspects, the model is operated at a different network node or a network entity.

According to a seventy-first aspect when referring back to any of the previous aspects, the monitoring entity is adapted to provide the monitoring report as a a long-time report; and/or to provide for an intermediate report or to provide for an intermediate counter measure indicator during a period of the long term monitoring to include information indicating a degree confidence of determined information and/or information on the monitoring period status

According to a seventy-second aspect when referring back to the seventy-first aspect, the monitoring entity is adapted to provide the report as an immediate report responsive to a received request.

According to a seventy-third aspect when referring back to the seventy-first aspect, the monitoring entity forms a part of a first network entity such as a UE, a BS or a core management function; adapted to extract a plurality of monitoring metrics associated with information received from other entities of the wireless communication system such as at least one BS, at least one UE and at least one core management function; wherein the received information is evaluated for at least a measurement result and/or measurement report and/or transmission and/or resource selection from the other entities.

According to a seventy-fourth aspect when referring back to the previous aspects, the monitoring entity of one of previous claims forming a part of a first network entity such as a UE, a BS or core management function; adapted to extract a plurality of monitoring metrics associated with a procedure between two or more entities of the wireless communication system such as at least one BS, at least one UE and at least one core management function; wherein the procedure includes at least an energy saving procedure and/or cell (re)-selection procedure and/or a handover procedure and/or an initial access procedure between the two or more entities.

According to a seventy-fifth aspect when referring back to any of the previous aspects, the monitoring entity is adapted to execute an identification of an AI/ML model functionality to determine a type of the model to be associated with a proprietary model or associated with an open-format model; and to request or provide information indicating the type of the model to the wireless communication system.

According to a seventy-sixth aspect when referring back to any of the previous aspects, the monitoring entity is adapted to exchange, with another entity of the wireless communication system, parameters associated with a structure or functionality supported by the AI/ML model, prior to execute the evaluation such that the evaluation is executed according to the functionality and/or the output is adapted based on the structure.

According to a seventy-seventh aspect when referring back to any of the previous aspects, the monitoring entity is adapted to determine a score that scores a quality of the AI/ML model based on the evaluation and to report the score to the wireless communication system, e.g., using a monitoring report.

According to a seventy-eighth aspect when referring back to any of the previous aspects, the monitoring entity is adapted to determine, based on the evaluation, a monitoring metric associated within a model inference output.

According to a seventy-ninth aspect when referring back to any of the previous aspects, the monitoring entity is adapted to provide a monitoring report to including the information based on the evaluation result and an associated time information.

According to an eightieth aspect when referring back to any of the previous aspects, the monitoring entity is adapted to provide a monitoring report to including the information based on the evaluation result and at least one of:
a model ID or functionality ID associated with the AI/ML model.
a model information, e.g., for open-format models
a configuration information such as an applied threshold, e.g., for open-format models.

An eighty-first aspect relates to a User Equipment, UE, adapted to operate in a wireless communication system, the UE comprising a monitoring entity according to one of the first to eightieth aspects.

According to an eighty-second aspect when referring back to the eighty-first aspect, the UE is to receive instructions to operate as the monitoring entity and to operate accordingly.

According to an eighty-third aspect when referring back to the eighty-second aspect, the UE is adapted to receive instructions indicating a time window during which the

UE is to operate as the monitoring entity and to operate accordingly.

According to an eighty-fourth aspect when referring back to the eighty-second or eighty-third aspect, the UE is adapted to request, based on the instructions to operate as the monitoring device, additional information that indicate at least one of parameters to be measured for the monitoring, a setting for the measurement and details about a report to be provided based on the monitoring.

According to an eighty-fifth aspect when referring back to any of the eighty-first to eighty-fourth aspect, the UE is to initiate a scheduled or a triggered monitoring session for evaluating the AI/ML model; wherein the scheduled session is preconfigured on defined or pre-defined intervals; wherein the triggered monitoring session is triggered from a network entity or an internal UE trigger determined by an AI/ML inference model.

According to an eighty-sixth aspect when referring back to any of the eighty-first to eighty-fifth aspects, the UE is to initiate a triggered monitoring session for evaluating the AI/ML model; wherein the triggered monitoring session is associated within an applicability criteria; wherein the applicability criteria comprises at least on of:
An indicated, configured or pre-configured validity area
A relative area indication determined with respect to a base station
One or more measurement(s) exceeding a given value; the measurements performed by the monitoring device on or in relation to one or more resources.
Activation, configuration or detection of one or more measurement(s).

According to an eighty-seventh aspect when referring back to any of the eighty-first to eighty-sixth aspects, the UE is to execute an identification of an AI/ML model functionality to determine a type of the model to be associated with a proprietary model or associated with an open-format model; and to provide information indicating the type of the model to the wireless communication system.

According to an eighty-eighth aspect when referring back to any of the eighty-first to eighty-seventh aspects, the UE is configured to provide information to the wireless communication system about a capability of the UE to execute the evaluation and/or to perform a root cause analysis on the monitoring metric.

According to an eighty-ninth aspect when referring back to the eighty-eighth aspect, the UE is to provide the information periodically, based on an event and/or upon request.

According to an ninetieth aspect when referring back to any of the eighty-first to eighty-ninth aspects, the UE is configured to identify supplementary information that supports the evaluation and to request the supplementary information and/or to measure the supplementary information and/or to identify and apply settings of a monitoring report provided by the UE.

According to an ninety-first aspect when referring back to any of the eighty-first to ninetieth aspects, the UE is configured for a performing a fault detection to derive the monitoring metric; the fault detection including one or more of fault analytics related to a predefined performance characteristic to provide an associated monitoring metric in case the predefined performance characteristic is present; and to generate a monitoring report containing information indicating the monitoring metric.

According to an ninety-second aspect when referring back to any of the eighty-first to ninety-first aspects, the UE is adapted to receive a root cause information indicating a root cause of a mismatch of the model and to determine, based on the root cause information, an action indicator indicating a counter measure to encounter the mismatch.

According to an ninety-third aspect when referring back to any of the eighty-first to ninety-second aspects, the UE is adapted for a single sided monitoring of the AI/ML model; and/or to participate in a coordinated monitoring of the AI/ML model.

According to an ninety-fourth aspect when referring back to any of the eighty-first to ninety-third aspects, the UE is adapted to UE identify a demand for monitoring, e.g., triggered by a fault detection; and is to request the wireless communication system or an entity thereof to configure a monitoring session, or to provide a monitoring/Processing gap.

According to a ninety-fifth aspect when referring back to the ninety-fourth aspect, the UE is adapted to provide information on a time interval required for the monitoring in the request.

A ninety-sixth aspect relates to a base station, BS, adapted to operate in a wireless communication system, the BS comprising a monitoring entity according to one of the first to eightieth aspects.

According to a ninety-seventh aspect when referring back to the ninety-sixth aspect, the BS is adapted for a single sided monitoring of the AI/ML model; and/or to participate in a coordinated monitoring of the AI/ML model.

A ninety-eighth aspect relates to a base station, BS, adapted to operate in a wireless communication system, the BS adapted to configure a different device to operate as a monitoring entity according to one of the first to eightieth aspects.

According to a ninety-ninth aspect when referring back to the ninety-eighth aspect, the BS is adapted to configure the different device with a time window during which the device is to operate as the monitoring entity.

According to a one hundredth aspect when referring back to the ninety-eighth or ninety-ninth aspect, the BS is configured to request information from the different device about a capability of the different device to execute the evaluation and/or to perform a root cause analysis on the monitoring metric and to instruct the different device based on the capability.

According to a one hundredth first aspect when referring back to the ninety-eighth to one hundredth aspects, the BS is to determine an availability of the different device for a monitoring and an inference and, e.g., to determine the fault detector and the root cause of the performance characteristic; and an unavailability of the different device to perform both, the monitoring and the inference simultaneously, and to instruct the different device to perform wither either the monitoring or the inference.

According to a one hundredth second aspect when referring back to the ninety-eighth to one hundredth first aspects, the BS is adapted to request at least one different entity to perform a monitoring of an AI/ML model based on a detected performance characteristic; wherein the detected performance characteristic is identified by the BS or reported from another monitoring entity.

According to a one hundredth third aspect when referring back to the ninety-eighth to one hundredth second aspects, the BS is adapted to provide the monitoring entity with information related to one or more detected or potential performance characteristics, e.g., faults.

According to a one hundredth fourth aspect when referring back to the ninety-eighth to one hundredth third aspects, the BS is adapted to include, into a monitoring a new monitoring entity to makes use of available information in case a similar performance characteristic was detected.

According to a one hundredth fifth aspect when referring back to the ninety-eighth to one hundredth fourth aspects, the BS is adapted to receive a root cause information indicating a root cause of a mismatch of the model and to determine, based on the root cause information, an action indicator indicating a counter measure to encounter the mismatch.

A one hundredth sixth aspect relates to a core management function, adapted to operate in a wireless communication system, the core management function comprising a monitoring entity according to one of the first to eightieth aspects.

According to a hundredth seventh aspect when referring back to the one hundredth sixth aspect, the core management function comprises a LMF (location management function), CMF (communication management function) or NWDAF (Network Data Analytics Function).

According to a hundredth eighth aspect when referring back to the one hundredth sixth or hundredth seventh aspect, the core management function is adapted to receive a root cause information indicating a root cause of a mismatch of the model and to determine, based on the root cause information, an action indicator indicating a counter measure to encounter the mismatch.

According to a hundredth ninth aspect when referring back to the one hundredth sixth or hundredth eighth aspect, the core management function is adapted for a single sided monitoring of the AI/ML model; and/or to participate in a coordinated monitoring of the AI/ML model.

A one hundred eleventh aspect relates to a core management function adapted to operate in a wireless communication system, the core management function adapted to configure a different device to operate as a monitoring entity according to one of the first to eightieth aspects.

According to a one hundred eleventh aspect when referring back to the one hundred tenth aspect, the core management function is adapted to configure the different device with a time window during which the device is to operate as the monitoring entity.

According to a one hundred twelfth aspect when referring back to the one hundred tenth or one hundred eleventh aspect, the core management function is configured to request information from the different device about a capability of the different device to execute the evaluation and/or to perform a root cause analysis on the monitoring metric and to instruct the different device based on the capability.

According to a one hundred thirteenth aspect when referring back to any of the one hundred sixth or one hundred twelfth aspects, the core management function is to determine an availability of the different device for a monitoring and an inference and, e.g., to determine the fault detector and the root cause of the performance characteristic; and an unavailability of the different device to perform both, the monitoring and the inference simultaneously, and to instruct the different device to perform wither either the monitoring or the inference.

A one hundred fourteenth aspect relates to a wireless communication system configured to provide a wireless service for at least one wireless device such as a UE or a base station, the wireless communication system comprising a monitoring entity according to one of the first to eightieth aspects.

A one hundred fifteenth aspect relates to method for evaluating an AI/ML model used in a wireless communication system, the method comprising: receiving model data associated with the model; executing an evaluation of the model data, by evaluating a plurality of sets of parameters derived from the model data with respect to a plurality of evaluated properties, each evaluated property associated with a set of parameters, to determine an associated monitoring metric, the associated monitoring metric indicating a performance of the model with respect to the evaluated property; and requesting, from a different network entity, additional information relating to the model; and using the additional information relating to the model for obtaining the plurality of associated monitoring metrics.

A one hundred sixteenth aspect relates to a method to operate a device in a wireless communication system, the method comprising: configuring a different device, e.g., using a wirelessly transmitted signal, to operate as a monitoring entity according to one of the first to eightieth aspects.

A one hundred seventeenth aspect relates to computer readable digital storage medium having stored thereon a computer program having a program code for performing, when running on a computer, a method according to the one hundred fifteenth or one hundred sixteenth aspect.

In view of the above, aspects of the present invention may, as an alternative or in addition, relate to:

### A. General 3GPP Framework

### 1. monitoring Entity is Related to UL,DL, UL+DL or SL Procedure

A monitoring entity residing in a first entity (example UE, BS, LMF)
Extracting a plurality of fault detection analytics associated with information of other entities (BS(s), other UE(s), LMF); wherein the information includes at least a measurement and/or measurement report and/or transmission and/or resource selection from the other entities.
Extracting a plurality of fault detection analytics associated with a procedure between two or more entities (BS(s), other UE(s), LMF); wherein the procedure includes at least an energy saving procedure and/or cell (re)-selection and/or handover and/or initial aces between the two or more entities.

### 2. “Proprietary Model” and “Open-Format Model”

In one alternative, the monitoring entity is configured to monitor or evaluate a proprietary model. Wherein proprietary format models are not mutually recognizable across vendors, hide model design information from other vendors when shared. In one example, a proprietary model is a device-specific binary executable format. Wherein the monitoring entity is to request side information or/and configuration or/and report or/and action indication without including model specific design information.

In a related aspect, a functionality identification process for identifying an AI/ML functionality for the common understanding between the NW and the UE can run prior to the monitoring session or triggered by the monitoring session.

If the model identified is a proprietary model then the monitoring entity can request or provide information according to the functionality identification.

In a second alternative, the monitoring entity is configured to monitor or evaluate an open-format model. Open-format models are mutually recognizable between vendors, do not hide model design information from other vendors when shared. In one example, Open-format models have a specified format that are mutually recognizable across vendors and allow interoperability, from 3GPP perspective.

### 3. Potential Counter Measures

Counter measures include: Indication of activation/deactivation/switching/fallback
UE may have one AI/ML model for the functionality, or UE may have multiple AI/ML models for the functionality. For model-ID-based procedure, indication of model selection/activation/deactivation/switching/fallback based on individual model IDs

### B. Fault Detection and Diagnosis Processing

Fault diagnosis may entail additional computational complexity. The device at which the monitoring entity is operating might not be able to perform a fault diagnosis in the background operation. In many scenarios, fault detection can be performed in parallel to the device operation, which can be the inference stage or performing a measurement. The monitoring entity can hence process the fault detection on a more frequent manner than fault diagnosis. This leads that monitoring entity especially when being performed at the UE might entail a processing gap to enable the monitoring procedure. Such a processing can be requested and/or initiated from a network core entity (LMF, NWDAF, CMF . . . ) or from the base station (gNB . . . ).

In accordance with one embodiment, the monitoring entity request from a network entity to initiate procedure for a monitoring diagnosis at the monitoring entity. In accordance with one embodiment, the network entity (LMF, CMF, NWDF, gNB, BS) initiates procedure for a monitoring diagnosis at the monitoring entity. Wherein for the monitoring entity being a UE. The network entity may request from the UE a capability information on the UE monitoring and inference capabilities.
UE capability for simultaneous monitoring and inference
   in case a UE is incapable of monitoring and inference simultaneously,
      option1: then the NW configures the monitoring entity to perform either monitoring or inference
      option2: UE identify a demand for monitoring (for example triggered by a fault detection); and request the NW: to configure a monitoring session, or a Monitoring [Processing] gap.
         UE can provide in the request information on the time interval required for monitoring

The network can also request from the UE monitoring capabilities related to the one or more faults. The network can request UE's capability on fault detection and/or fault diagnosis. In a further step, the network can request if the UE can provide capability on common/standardized fault detection and/or diagnosis analytics. For the later, the analytic capabilities can be application or use case or sub use case specific.
UE Capability for fault detection and fault diagnosis
   Fault detection capabilities
   Fault diagnosis capabilities

In accordance with one embodiment, a network entity (BS or LMF) request one or more monitoring entity (UEs or BSs) to perform monitoring based on a detected fault. Wherein the detected fault is either identified by the network entity itself or reported from another monitoring entity.

In accordance with one embodiment, a network entity (BS or LMF) provide the monitoring entity with information related to a one or more detected or potential fault.

In one example, a multiple monitoring entities can provide performance degradation in the positioning performance from the AI/ML model. The monitoring entities can provide the network in the report with information on the detected faults and the associated diagnosis and/or applied counter measures additionally under which circumstances. The network can provide information to a new monitoring entity in the positioning area so that it makes use of available information in case a similar fault was detected.

### C. Reports/Actions: Long-Period/Intermediate, Immediate, Predictive

Generating a predictive report or a predictive related action indication, the report or action based on the monitoring entity output, wherein the predictive report includes information of one or more expected future Fault Indication(s) in the wireless communication system.
Generating a long-period report or a long-period action indication, wherein for the long period monitoring the monitoring entity analyses one or more fault detection(s) corresponding to multiple time instants. The fault detection(s) may correspond to historical time instants.
   Wherein the fault diagnosis is to identify similarities among the multiple time instants, wherein the multiple time instants of fault detection(s) is grouped into at least one set of fault analytics based on the identified similarities.
   Generating an intermediate report or an intermediate action indication, the report or action based on the monitoring output, wherein the intermediate report includes information of the monitoring related to one or more Fault Indication(s). The indication or report can include a degree of confidence or information on the monitoring period status.
Generating an immediate report or an immediate related action indication, the report or action based on the monitoring entity output, wherein the immediate report includes information of one or more detected Fault Indication(s) in the wireless communication system. The immediate report or action is based on a request from a network entity or a report/action configuration or a pre-configuration.
Providing by the monitory entity information in the report; wherein the information include(s) the Fault mitigation action or other action (such as fallback or select a different model) for the identified Fault(s) if applicable.

### UE Aspects

The details presented herein provide for a UE that is related to the signaling, reporting and UE procedure

Such a UE may include or provide a single side or two sided AI/ML model inference monitoring entity, described herein. Such a UE may optionally be adapted for
Executing an AI/ML model-based or functionality-based identification process; wherein the UE is to provide the NW with information on the model type proprietary model or open-format model;
If requested by the network, provide a UE capability on AI/ML monitoring, e.g., by sending respective information by the UE or a different entity having such information available;
Identify the additional data (502,504) and/or monitoring report settings.
Initiating a scheduled or a triggered monitoring session; wherein the scheduled session is preconfigured on defined or pre-defined intervals; wherein the triggered monitoring session is triggered from a network entity or an internal UE trigger determined by the AI/ML inference model
Performing a fault detection; the fault detection including one or more of fault analytics; and
Generating a monitoring report.

For example, a triggered monitoring session may be initiated by a UE or a different entity for any reason, e.g., cyclically, upon demand and/or based on an event. According to embodiments, the UE or another entity or an underlying information/data may indicate to associate the triggered monitoring session with an an applicability criteria. That is, such a device (UE) may initiate a triggered monitoring session for evaluating the AI/ML model, the triggered monitoring session being optionally associated with the applicability criteria. Such an applicability criteria may comprise, amongst others, at least one of:
An indicated, configured or pre-configured validity area, e.g., a zone where monitoring is desired from the NW or the UE.
A relative area indication determined with respect to a base station or a different entity.
One or more measurement(s) exceeding a given value; the measurements performed by the monitoring device on or in relation to one or more resources such as an RSRP-value being greater than −110 dBm; and/or in positioning that a TDOA uncertainty is signaled as a difference between two resources; and
An activation, configuration or detection of one or more measurement(s).

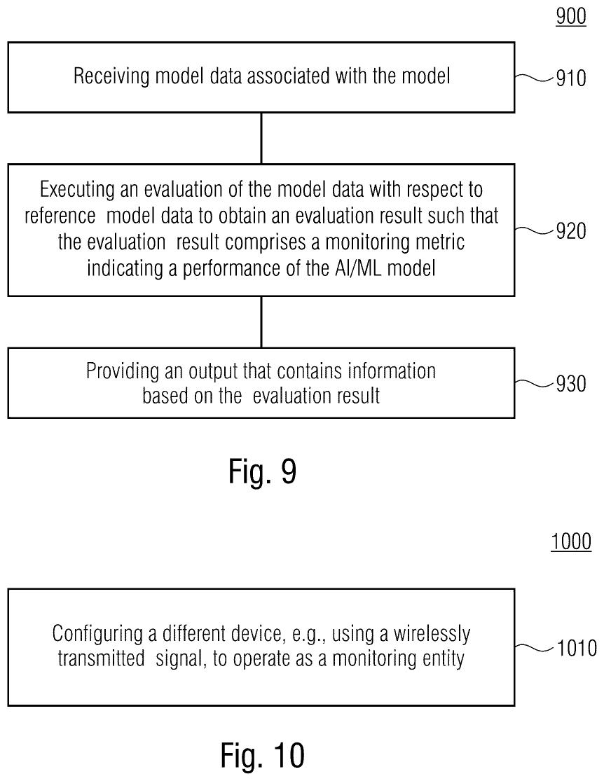

FIG. 9 shows a schematic flow chart of a method 900 according to an embodiment. A step 910 comprises receiving model data associated with the model. A step 920 comprises executing an evaluation of the model data with respect to reference model data to obtain an evaluation result such that the evaluation result comprises a monitoring metric indicating a performance of the AI/ML model. A step 930 comprises providing an output that contains information based on the evaluation result. Method 900 may be used for evaluating an AI/ML model used in a wireless communication system.

FIG. 10 shows a schematic flow chart of a method 1000 according to an embodiment having a step 1010 comprising configuring a different device, e.g., using a wirelessly transmitted signal to operate as a monitoring entity described herein.

### AI/ML Model Deployed at UE

### Fault Detection at UE; Fault Diagnosis/Handling at Network Node

### Core Functionality of UE

Implementation 1. A monitoring entity for monitoring a behavior of an artificial intelligence/machine learning, AI/ML, model, the AI/ML model being configured to process input data to obtain output data, the monitoring entity comprising, for example:
a processor;
a memory coupled with the processor; and
machine-executable instructions stored in the memory, the machine-executable instructions being operable, when executed by the processor, to cause the monitoring entity:
to receive the input data and the output data;
to receive side information, the side information being associated with the AI/ML model; and
to monitor the behavior of the AI/ML model based on the input data, the output data and/or the side information to obtain a fault indicator, the fault indicator indicating the behavior of the AI/ML model.

### Fault Detection: Inference Input and Training Data Mismatch

Implementation 2. The monitoring entity of implementation 1 may be adapted the the AI/ML model has been trained using training data, wherein monitoring the behavior of the AI/ML model comprises:
determining a first statistical value associated with the input data;
determining a second statistical value associated with the training data based on the side information;
comparing the first statistical value and the second statistical value; and
detecting a fault in the behavior of the AI/ML model if a deviation between the first statistical value and the second statistical value exceeds a threshold value, the fault indicator indicating the fault in the behavior of the AI/ML model.

### Fault Detection: Inference Output Inconsistency

Implementation 3. The monitoring entity of any one of the preceding implementations may be adapted that monitoring the behavior of the AI/ML model comprises:
extracting an output value from the output data;
determining an expected output value based on the side information;
comparing the output value and the expected output value;
detecting a fault in the behavior of the AI/ML model if a deviation between the output value and the expected output value exceeds a threshold value, the fault indicator indicating the fault in the behavior of the AI/ML model.

### Further Aspects Relate to

A. A user equipment, UE, comprising:
[AI/ML model deployed in UE]

B. A network node, gNB, comprising:
[AI/ML model deployed in gNB]

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A monitoring entity for an AI/ML model used in a wireless communication system, wherein the monitoring entity is configured to:
receive model data associated with the model;
execute an evaluation of the model data, using a plurality of analyser modules of the monitoring entity, wherein each analyser module is configured for evaluating an associated set of parameters derived from the model data with respect to an evaluated property to determine an associated monitoring metric associated with the analyser module, the associated monitoring metric indicating a performance of the model with respect to the evaluated property; and
wherein the monitoring entity is adapted to request, from a different network entity, e.g., a UE or the network, additional information relating to the model; and to use the additional information relating to the model for acquiring the plurality of associated monitoring metrics.

2. The monitoring entity of claim 1, wherein the evaluated property relates to a channel characteristic.

3. The monitoring entity of claim 1, wherein monitoring entity is configured to select one of the plurality of associated monitoring metrics to form a basis for the evaluation result based on a hierarchical order of the analyser modules or of the associated monitoring metrics.

4. The monitoring entity of claim 1, wherein at least one analyser module is adapted to evaluate the associated set of parameters with respect to be in accordance with a predefined parameter range.

5. The monitoring entity of claim 1, wherein, for determining the associated monitoring metrics, the plurality of analyser modules is configured to evaluate measurements on resources of the wireless communication system in which the model is operated, the measurements associated with an input and/or output of a model inference to determine the associated monitoring metric; and/or
to evaluate values derived from the measurements on the resources to determine the associated monitoring metric.

6. The monitoring entity of claim 1, adapted to determine, based on the monitoring metric, a root cause information indicating a root cause of a match or mismatch between an observed behaviour of the AI/ML model and a modelled behaviour of the AI/ML model and to provide the monitoring metric to indicate the match or mismatch.

7. The monitoring entity of claim 6; wherein a counter measure to encounter the mismatch comprises, e.g., in a case where the monitoring entity operates for a network-side monitoring:
an indication to activate a functionality or model;
an indication deactivate a functionality or model;
an indication to switch a functionality or model; and/or
an indication to operate according to a predefined fall back option

8. The monitoring entity of claim 6; wherein a counter measure to encounter the mismatch comprises, e.g., in a case where the monitoring entity operates for a UE-side monitoring, an update on supported model functionalities.

9. The monitoring entity of claim 1, adapted to determine, based on the evaluation, a monitoring metric associated with a functionality of the AI/ML model, e.g., represented as an functionality ID and to report the monitoring metric to the wireless communication system, e.g., using a monitoring report.

10. The monitoring entity of claim 1, adapted to determine a score that scores a quality of the AI/ML model based on the evaluation and to report the score to the wireless communication system, e.g., using a monitoring report.

11. A User Equipment, UE, adapted to operate in a wireless communication system, the UE comprising a monitoring entity according to claim 1.

12. The UE of claim 11, adapted to request, based on the instructions to operate as the monitoring device, additional information that indicate at least one of parameters to be measured for the monitoring, a setting for the measurement and details about a report to be provided based on the monitoring.

13. The UE of claim 11, configured to provide information to the wireless communication system about a capability of the UE to execute the evaluation and/or to perform a root cause analysis on the monitoring metric.

14. The UE of claim 11, wherein the UE is adapted to UE identify a demand for monitoring, e.g., triggered by a fault detection; and is to request the wireless communication system or an entity thereof to configure a monitoring session, or to provide a monitoring/Processing gap.

15. The UE of claim 14, adapted to provide information on a time interval required for the monitoring in the request.

16. A base station, BS, adapted to operate in a wireless communication system, the BS comprising a monitoring entity according to claim 1.

17. A core management function, adapted to operate in a wireless communication system, the core management function comprising a monitoring entity according to claim 1.

18. A method for evaluating an AI/ML model used in a wireless communication system, the method comprising:
receiving model data associated with the model;
executing an evaluation of the model data, by evaluating a plurality of sets of parameters derived from the model data with respect to a plurality of evaluated properties, each evaluated property associated with a set of parameters, to determine an associated monitoring metric, the associated monitoring metric indicating a performance of the model with respect to the evaluated property; and
requesting, from a different network entity, additional information relating to the model; and using the additional information relating to the model for acquiring the plurality of associated monitoring metrics.
